(19) United States
(12) Patent Application Publication
(10) Pub. No.: US 2026/0197763 A1
(43) Pub. Date: Jul. 9, 2026

(54) SIGNALS WITH OVERLAID SEQUENCES

(71) Applicant: QUALCOMM Incorporated, San Diego, CA (US)

(72) Inventors: Huilin XU, Beijing (CN); Nicolas CORNILLET, Lannion (FR); Kazuki TAKEDA, Minato-ku (JP); Yuchul KIM, San Diego, CA (US)

(21) Appl. No.: 19/427,995

(22) Filed: Dec. 19, 2025

Related U.S. Application Data
(60) Provisional application No. 63/743,076, filed on Jan. 8, 2025.

(51) Int. Cl. H04W 52/02; H04L 27/04

(52) U.S. Cl. CPC H04W 52/0235; H04L 27/04

(57) ABSTRACT

A method for wireless communication at a user equipment (UE) and related apparatus are provided. In the method, the UE receives a wakeup signal (WUS) from a network entity. The WUS includes multiple overlaid sequences, and the WUS includes a first zero interval that is adjacent to the beginning of one or more overlaid sequences of the multiple overlaid sequences and a second zero interval that is adjacent to the end of one or more overlaid sequences of the multiple overlaid sequences. The UE then monitors a physical downlink control channel (PDCCH) based on the WUS.

### CROSS REFERENCE TO RELATED APPLICATION(S)

This application claims the benefit of and priority to U.S. Provisional Application Ser. No. 63/743,076, entitled “SIGNALS WITH OVERLAID SEQUENCES” and filed on Jan. 8, 2025, which is expressly incorporated by reference herein in its entirety.

### TECHNICAL FIELD

The present disclosure relates generally to communication systems and, more particularly, to the design of signal sequences in wireless communication.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 6G, which is an enhancement of 5G New Radio (NR) and is a part of a continuous mobile broadband evolution promulgated by Third Generation Partnership Project (3GPP) to meet new requirements associated with latency, reliability, security, scalability (e.g., with Internet of Things (IoT)), capacity, location services, energy efficiency, artificial intelligence (AI) integration, and other requirements. Some aspects of 6G may be based on 5G NR and 4G Long Term Evolution (LTE). There exists a need for further improvements in 6G/5G technology.

These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided for wireless communication at a user equipment (UE). The apparatus may include at least one memory and at least one processor coupled to the at least one memory. Based at least in part on information stored in the at least one memory, the at least one processor may be configured to receive, from a network entity, a wakeup signal (WUS) including multiple overlaid sequences, where the WUS includes a first zero interval that is adjacent to the beginning of one or more overlaid sequences of the multiple overlaid sequences and a second zero interval that is adjacent to the end of one or more overlaid sequences of the multiple overlaid sequences; and monitor for a physical downlink control channel (PDCCH) based on the WUS.

In an aspect of the disclosure, a method, a computer-readable medium, and an apparatus are provided for wireless communication at a user equipment (UE). The apparatus may include at least one memory and at least one processor coupled to the at least one memory. Based at least in part on information stored in the at least one memory, the at least one processor may be configured to receive, from a network entity, a synchronization signal (SS) including a first number of on-off keying (OOK) symbols per orthogonal frequency-division multiplexing (OFDM) symbol, where the first number of OOK symbols is different from a second number of OOK symbols per OFDM symbol in a WUS; and communicate with the network entity based on the SS.

In an aspect of the disclosure, a method, a computer-readable medium, and an apparatus are provided for wireless communication at a network entity. The apparatus may include at least one memory and at least one processor coupled to the at least one memory. Based at least in part on information stored in the at least one memory, the at least one processor may be configured to transmit, to a user equipment (UE), an WUS including multiple overlaid sequences, where the WUS includes a first zero interval adjacent to the beginning of one or more overlaid sequences of the multiple overlaid sequences and a second zero interval that is adjacent to the end of one or more overlaid sequences of the multiple overlaid sequences; and transmit, to the UE, a PDCCH based on the WUS.

In an aspect of the disclosure, a method, a computer-readable medium, and an apparatus are provided for wireless communication at a network entity. The apparatus may include at least one memory and at least one processor coupled to the at least one memory. Based at least in part on information stored in the at least one memory, the at least one processor may be configured to transmit, to a UE, an SS, where the SS has a first number of OOK symbols per OFDM symbol, where the first number of OOK symbols is different from a second number of OOK symbols per OFDM symbol in an WUS; and communicate with the UE based on the SS.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communication system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of a low power wakeup radio (LP-WUR) and a main radio (MR).

FIG. 5 is a diagram illustrating examples of an on-off keying (OOK) modulation and an orthogonal frequency-division multiplexing (OFDM) modulation in a wakeup signal (WUS) in accordance with various aspects of the present disclosure.

FIG. 6A is a diagram illustrating the interferences between the overlaid sequences in an orthogonal frequency division multiplexing (OFDM) symbol.

FIG. 6B is a diagram illustrating an example of zero regions added to before the beginning and after the end of the overlaid sequences in accordance with various aspects of the present disclosure.

FIG. 7 shows diagrams illustrating various options for the number of zeros added to the overlaid sequences in accordance with various aspects of the present disclosure.

FIG. 8 shows diagrams illustrating the examples of overlaid sequences for a WUS and a synchronization signal (SS) in accordance with various aspects of the present disclosure.

FIG. 9 is a diagram illustrating various beams for WUS and SS transmissions in accordance with various aspects of the present disclosure.

FIG. 10 is a call flow diagram illustrating a method of wireless communication in accordance with various aspects of the present disclosure.

FIG. 11 is a flowchart illustrating methods of wireless communication at a UE in accordance with various aspects of the present disclosure.

FIG. 12 is a flowchart illustrating methods of wireless communication at a UE in accordance with various aspects of the present disclosure.

FIG. 13 is a flowchart illustrating methods of wireless communication at a UE in accordance with various aspects of the present disclosure.

FIG. 14 is a flowchart illustrating methods of wireless communication at a network entity in accordance with various aspects of the present disclosure.

FIG. 15 is a flowchart illustrating methods of wireless communication at a network entity in accordance with various aspects of the present disclosure.

FIG. 16 is a flowchart illustrating methods of wireless communication at a network entity in accordance with various aspects of the present disclosure.

FIG. 17 is a diagram illustrating an example of a hardware implementation for an example apparatus and/or UE.

FIG. 18 is a diagram illustrating an example of a hardware implementation for an example network entity.

### DETAILED DESCRIPTION

In wireless communication, a wakeup signal (WUS), including a low power WUS (LP-WUS) or a downlink WUS (DL WUS), may be used to help user equipment (UE) to conserve power consumption. Monitoring the physical downlink control channel (PDCCH) using WUS (e.g., LP-WUS) consumes less power compared to using the main radio of the UE. The UE may include a low power wakeup radio (LP-WUR or LR) and a main radio (MR). When the LP-WUR is activated to monitor LP-WUS, the MR may enter the sleep mode to save power. Upon receiving an LP-WUS that triggers PDCCH monitoring, the MR may switch to an active state to monitor the PDCCH. The LP-WUS may be generated at the base station using on-off keying (OOK) modulation and underlying orthogonal frequency-division multiplexing (OFDM) sequences. LP-WUS may use two types of modulations: OOK modulation and OFDM modulation. The OOK modulation may carry information through the envelope of the LP-WUS waveform, representing one of two binary states within a time duration. On the other hand, the OFDM modulated waveforms can carry more than a single bit of information. In some scenarios, an LP-WUS may include overlaid sequences, which include an OOK waveform superimposed onto an OFDM waveform. Additionally, a synchronization signal (SS), such as a low power SS (LP-SS), may be provided for the LP-WUR to ensure timing synchronization and facilitate radio resource management (RRM) measurements. Both OOK modulation and overlaid sequences can also be applied to an SS. Example aspects presented herein provide design details for overlaid sequences applicable to WUS (e.g., LP-WUS or DL WUS) and an SS (e.g., an LP-SS), including considerations for mitigating the cyclic prefix (CP) issue, configuring different numbers of OOK symbols per OFDM symbol (e.g., M) for WUS (e.g., LP-WUS or DL WUS) and SS (e.g., an LP-SS), and managing beams for WUS (e.g., LP-WUS or DL WUS) and SS (e.g., LP-SS) transmissions.

Various aspects relate generally to wireless communication. Some aspects more specifically relate to the design of overlaid sequences in wireless communication. In some examples, a UE may receive, from a network entity, a WUS (e.g., an LP-WUS or a DL WUS) including multiple overlaid sequences. The WUS may include a first zero interval that is adjacent to the beginning of one or more overlaid sequences of the multiple overlaid sequences and a second zero interval that is adjacent to the end of one or more overlaid sequences of the multiple overlaid sequences. The UE may monitor for a PDCCH based on the WUS. In some examples, the UE may receive, from a network entity, an SS (e.g., an LP-SS). The SS may have a first number of OOK symbols per OFDM symbol, and the first number of OOK symbols may be different from a second number of OOK symbols per OFDM symbol in a WUS. The UE may communicate with the network entity based on the SS. In some examples, the UE may receive the SS in either all synchronization signal block (SSB) beams or a subset of SSB beams of the network entity, depending on whether the network entity supports a modulation of the overlaid sequence on the SS. In some examples, the UE may receive the WUS in either all SSB beams or a subset of SSB beams of the network entity, depending on whether the network entity supports a modulation of the overlaid sequence on the WUS.

Particular aspects of the subject matter described in this disclosure can be implemented to realize one or more of the following potential advantages. In some examples, by introducing intervals of zeros (or gaps of zeros) before and after overlaid sequences, the described techniques prevent mixing of these sequences in multipath propagations (e.g., where transmitted signals can take multiple paths to reach the receiver due to reflection, diffraction, and scattering from objects in the environment like buildings, trees, and walls), thereby minimizing interference between the overlaid sequences and ensuring reliable wakeup detection. In some examples, by enabling the configuration of different numbers of OOK symbols (or information bits) in an OFDM symbol for WUS (e.g., an LP-WUS or a DL WUS) and SS (e.g., an LP-SS), the described techniques improve synchronization accuracy and detection reliability under various operational conditions. In some examples, by supporting WUS and SS transmissions in all or a subset of SSB beams based on network configuration, the described techniques ensure efficient resource utilization for varying network capabilities and coverage conditions.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer. While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 6G systems, may be arranged in multiple manners with various components or constituent parts. In a 6G system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

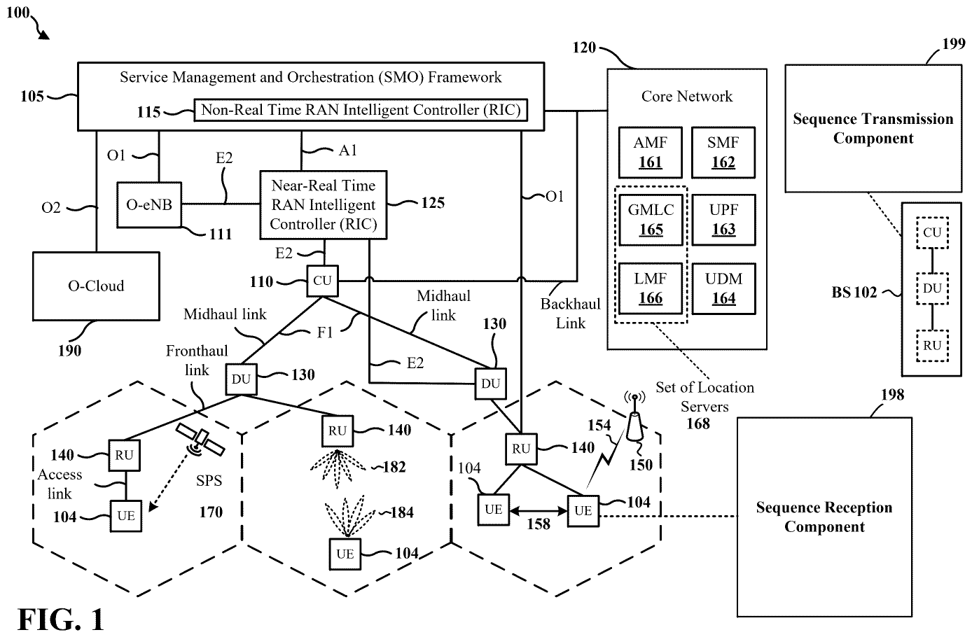

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140. Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an 01 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. Two initial operating bands have been identified as frequency range designations FR1 (410 MHz-7.125 GHZ) and FR2 (24.25 GHz-52.6 GHZ). Although a portion of FR1 is greater than 6 GHz, FRI is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent studies have identified an operating band for these mid-band frequencies as frequency range designation FR3 (7.125 GHZ-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend operation beyond 52.6 GHz. For example, three higher operating bands have been identified as frequency range designations FR2-2 (52.6 GHz-71 GHz), FR4 (71 GHz-114.25 GHZ), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

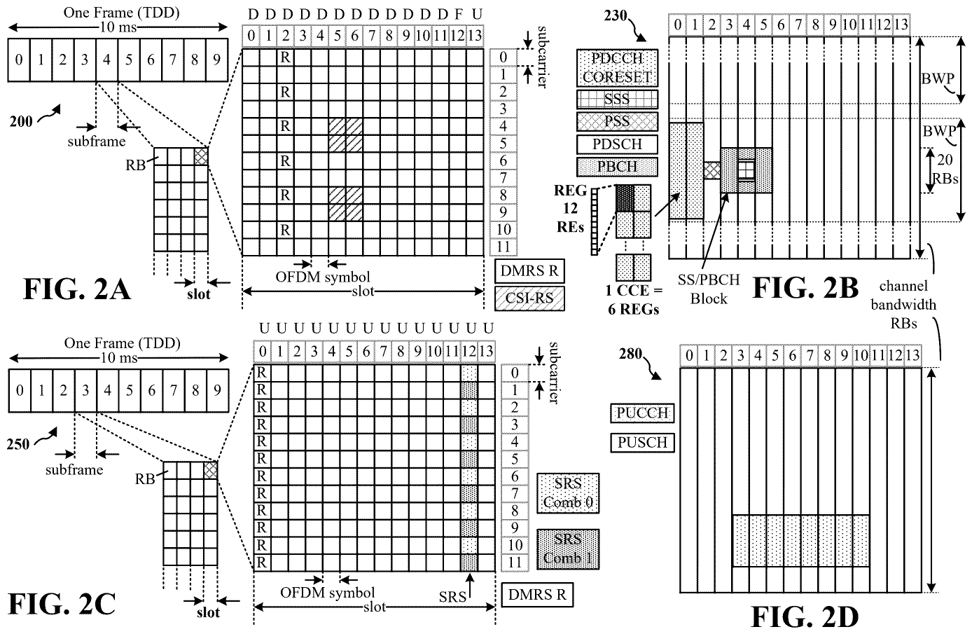

Referring again to FIG. 1, in certain aspects, the UE 104 may include the sequence reception component 198. In some aspects, the sequence reception component 198 may be configured to receive, from a network entity, a WUS (e.g., an LP-WUS or a DL WUS) including multiple overlaid sequences, where the WUS includes a first zero interval that is adjacent to the beginning of one or more overlaid sequences of the multiple overlaid sequences and a second zero interval that is adjacent to the end of one or more overlaid sequences of the multiple overlaid sequences; and monitor for a PDCCH based on the WUS. In some aspects, the sequence reception component 198 may be configured to receive, from a network entity, an SS (e.g., an LP-SS), where the SS has a first number of OOK symbols per OFDM symbol, where the first number of OOK symbols is different from a second number of OOK symbols per OFDM symbol in a WUS; and communicate with the network entity based on the SS. In certain aspects, the base station 102 may include the sequence transmission component 199. In some aspects, the sequence transmission component 199 may be configured to transmit, to a UE, a WUS (e.g., an LP-WUS or a DL WUS) including multiple overlaid sequences, where the WUS includes a first zero interval that is adjacent to the beginning of one or more overlaid sequences of the multiple overlaid sequences and a second zero interval that is adjacent to the end of one or more overlaid sequences of the multiple overlaid sequences; and transmit, to the UE, a PDCCH based on the WUS. In some aspects, the sequence transmission component 199 may be configured to transmit, to a UE, an SS (e.g., an LP-SS), where the SS has a first number of OOK symbols per OFDM symbol, where the first number of OOK symbols is different from a second number of OOK symbols per OFDM symbol in a WUS; and communicate with the UE based on the SS. Although the following description may be focused on 5G NR, the concepts described herein may be applicable to other similar areas, such as LTE, LTE-A, CDMA, GSM, and other wireless technologies. FIG. 2A is a diagram 200 illustrating an example of a first subframe. FIG. 2B is a diagram 230 illustrating an example of DL channels within a subframe. FIG. 2C is a diagram 250 illustrating an example of a second subframe within a frame structure. FIG. 2D is a diagram 280 illustrating an example of UL channels within a subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies u 0 to 4 allow for 1, 2, 4, 8, and 16 slots, respectively, per subframe. For extended CP, the numerology 2 allows for 4 slots per subframe. Accordingly, for normal CP and numerology u, there are 14 symbols/slot and 24 slots/subframe. The subcarrier spacing may be equal to 2^{μ}*15 kHz, where u is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

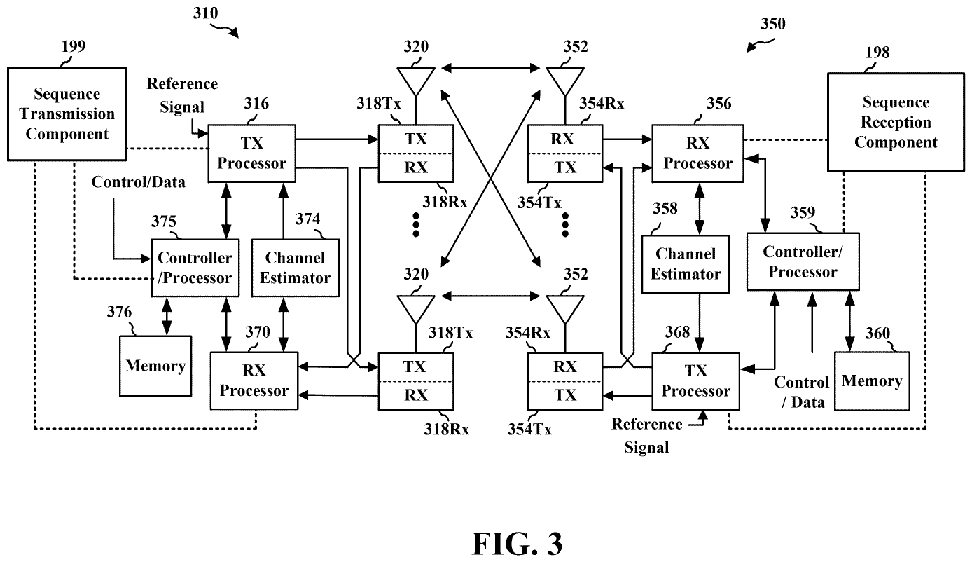

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the sequence reception component 198 of FIG. 1.

At least one of the TX processor 316, the RX processor 370, and the controller/processor 375 may be configured to perform aspects in connection with the sequence transmission component 199 of FIG. 1.

In wireless communication, a WUS (e.g., an LP-WUS or a DL WUS) may be used to help the UE to conserve power consumption. A UE may include a low power wakeup radio (LP-WUR or LR) for monitoring for the LP-WUS and an MR. Monitoring the PDCCH using LP-WUS consumes less power compared to using the main radio of the UE. When the LP-WUR is activated to monitor LP-WUS, the MR may enter the sleep mode to save power. Upon receiving an LP-WUS that triggers PDCCH monitoring, the MR may switch to an active state to monitor the PDCCH. The LP-WUS may be generated at the base station using OOK modulation and underlying OFDM sequences. LP-WUS may use two types of modulations: OOK modulation and OFDM modulation. The OOK modulation may carry information through the envelope of the LP-WUS waveform, representing one of two binary states (e.g., “1” or “0”) within a time duration. On the other hand, the OFDM modulated waveforms can carry more than a single bit of information. In some scenarios, an LP-WUS may include overlaid sequences, which include an OOK waveform superimposed onto an OFDM waveform. Additionally, an SS, such as an LP-SS, may be provided for the LP-WUR to ensure timing synchronization and facilitate RRM measurements. Both OOK modulation and overlaid sequences can also be applied to the SS. Example aspects presented herein provide design details for overlaid sequences applicable to WUS (e.g., an LP-WUS or a DL WUS) and SS (e.g., an LP-SS), including considerations for mitigating the CP issue, configuring different numbers of OOK symbols per OFDM symbol (e.g., M) for WUS (e.g., an LP-WUS or a DL WUS) and SS (e.g., LP-SS), and managing beams for WUS and SS transmissions.

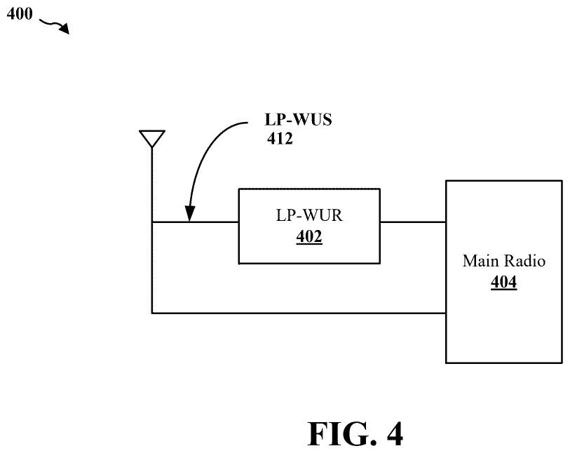

In wireless communication, a UE may be equipped with a low power wakeup radio (LP-WUR) that utilizes significantly less battery power than other radios (e.g., the main radio or MR). FIG. 4 is a diagram 400 illustrating an example of an LP-WUR and an MR. As shown in FIG. 4, the LP-WUR 402 may be configured to receive a WUS 412 (e.g., an LP-WUS or a DL WUS), which may help the UE to conserve battery power by replacing traditional PDCCH monitoring (e.g., via MR 404) with WUS (e.g., LP-WUS or DL WUS) triggered PDCCH monitoring (e.g., via LP-WUR 402). This approach may significantly reduce the power consumption of the UE, as PDCCH monitoring based on WUS (e.g., an LP-WUS or a DL WUS) consumes much less power compared to continuous PDCCH monitoring via, for example, the MR 404.

In some examples, the UE may include the LP-WUR (or LR) 402 and the MR 404, which function as the current wireless transceiver. When the LP-WUR 402 is enabled to monitor a WUS 412, the MR 404 may enter the sleep mode to save power. Upon receiving a WUS 412 that triggers PDCCH monitoring for the UE, the MR 404 may be switched to an active state to monitor for the PDCCHs.

In some examples, a WUS 412 (e.g., an LP-WUS or a DL WUS) may be generated at the base station using OOK modulation and underlying OFDM sequences. At the UE, the WUS 412 (e.g., an LP-WUS or a DL WUS) may be detected either by an envelope detection (ED)-based LP-WUR or an OFDM-based LP-WUR. The power-saving advantage may be achieved by replacing constant PDCCH monitoring with WUS-triggered PDCCH monitoring. As used herein, an “OOK modulation” may refer to a modulation scheme that uses the presence or absence of a carrier signal to represent binary data.

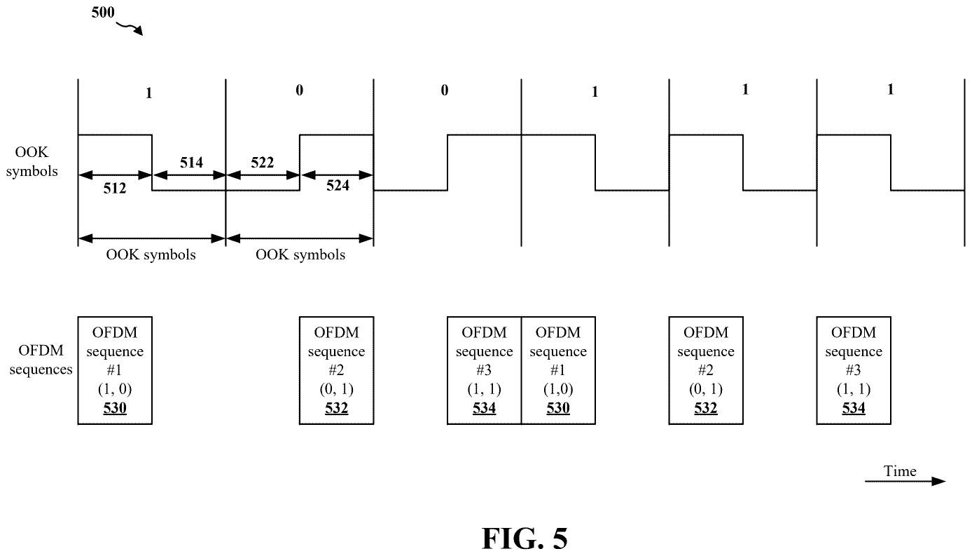

In some examples, a WUS (e.g., WUS 412) may include two types of modulations: OOK and OFDM modulations. FIG. 5 is a diagram 500 illustrating examples of the OOK modulation and OFDM modulation in a WUS (e.g., an LP-WUS or a DL WUS) in accordance with various aspects of the present disclosure. As shown in FIG. 5, OOK modulation may carry information through the envelope of the WUS waveform. For example, the presence or absence of energy during a specific time duration may indicate one of two binary states (e.g., “1” or “0”) within that duration. For example, as shown in FIG. 5, the OOK symbol 512 (i.e., an OOK “On” symbol) may include a time period with the presence of energy (e.g., a high-voltage signal), and the OOK symbol 514 (i.e., an OOK “Off” symbol) may include a time period with the absence of energy (e.g., a low-voltage signal). The OOK symbol 512, 514 may represent the binary information bit of “1.” In another example, the OOK symbol 522 may include a time period with the absence of energy (e.g., a low-voltage signal), and the OOK symbol 524 may include a time period with the presence of energy (e.g., a high-voltage signal). The OOK symbol 522, 524 may represent the binary information bit of “0.”

The OFDM-modulated waveform (which may also be referred to as “OFDM waveform” or “OFDM sequence”) may be transmitted during a time duration to provide energy where energy is present for the OOK modulation in the same duration (e.g., in OOK symbol 512, 524). For example, referring to FIG. 5, the OFDM sequence #1 530 may be transmitted with OOK symbol 512, where energy (e.g., a high-voltage signal) is present for the OOK modulation, and the OFDM sequence #2 532 may be transmitted with OOK symbol 524, where energy (e.g., a high-voltage signal) is present for the OOK modulation. An OFDM-modulated waveform (or OFDM waveform) may carry multiple bits of information. For example, if the network transmits one of multiple (e.g., N) candidate OFDM waveforms, the OFDM waveform can carry log₂ N bits of information. For example, referring to FIG. 5, four candidate OFDM waveforms (i.e., N-4) may be provided, and each of these candidate OFDM waveforms may carry two bits of information (i.e., log 2 4=2). For example, the first candidate OFDM waveform (e.g., OFDM sequence #1 530) may represent the 2-bit information of (1, 0), the second candidate OFDM waveform (e.g., OFDM sequences #2 532) may represent the 2-bit information of (0, 1), the third candidate OFDM waveform (e.g., OFDM sequence #3 534) may represent the 2-bit information of (1, 1), and the fourth candidate OFDM waveform may represent the 2-bit information of (0, 0).

In some examples, while OFDM waveforms detection may have a relatively higher power consumption than energy detection for OOK symbols, OFDM waveforms can be detected in lower signal-to-noise ratio (SNR) conditions compared to OOK envelopes. This characteristic allows UEs to detect wakeup information more quickly over a broader area within the cell, compensating for the higher detection power of a WUS (e.g., an LP-WUS or a DL WUS).

In some examples, the UE implementation may support either an OOK detector that can detect wakeup information solely from the OOK envelope (e.g., the OOK envelop of OOK symbol 512, 514, 522, 524) of the WUS (e.g., LP-WUS or DL WUS) or an OFDM receiver capable of detecting the underlying OFDM sequences, such as OFDM sequence #1 530, OFDM sequence #2 532, and OFDM sequence #3 534. In some examples, a WUS (e.g., an LP-WUS or a DL WUS) may include overlaid sequences, which include an OOK waveform superimposed onto an OFDM waveform. For example, in FIG. 5, an overlaid sequence may include the waveform of OOK “On” symbol 512 superimposed with the OFDM sequence #1 530. Another overlaid sequence may include the waveform of OOK “On” symbol 524 superimposed with the OFDM sequence #2 532.

In some examples, an SS, such as an LP-SS, may be provided for the LP-WUR to maintain timing synchronization and facilitate radio resource management (RRM) measurements. In some examples, both OOK modulation and overlaid sequences are also applied to SS. Example aspects presented herein provide design details for overlaid sequences applicable to a WUS (e.g., an LP-WUS or a DL WUS) and SS (e.g., an LP-SS), including considerations for mitigating the CP issue, configuring different numbers of OOK symbols per OFDM symbol (e.g., M) for WUS and SS, and managing beams for WUS and SS transmissions.

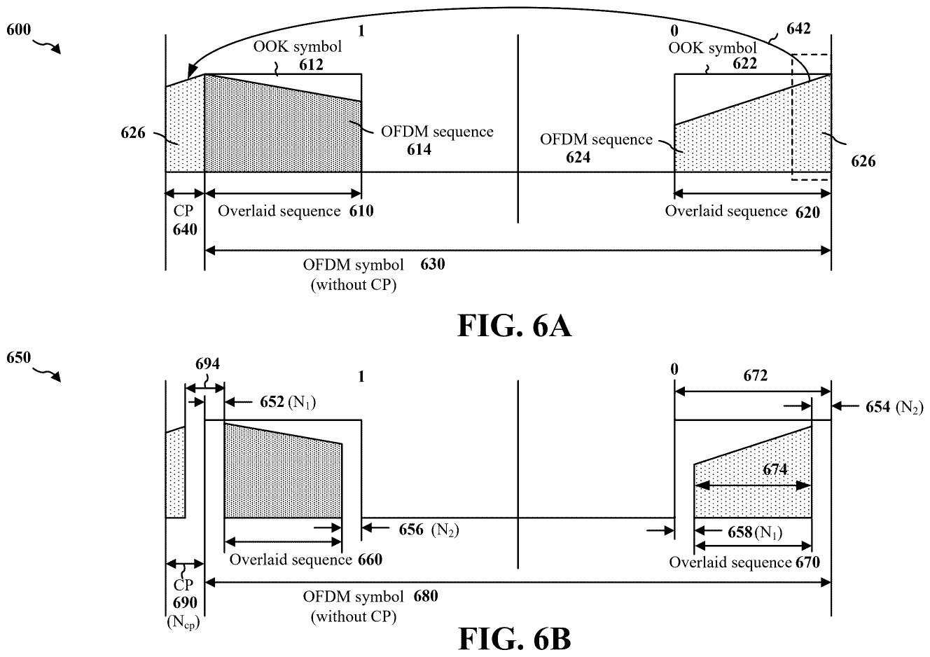

FIG. 6A is a diagram 600 illustrating the interferences between the overlaid sequences in an OFDM symbol. As shown in FIG. 6A, an OFDM symbol 630 may include two overlaid sequences: the first overlaid sequence 610 and the second overlaid sequence 620. The first overlaid sequence 610 may include the waveform of an OOK symbol 612 superimposed with the waveform of OFDM sequence 614, and the second overlaid sequence 620 may include the waveform of an OOK symbol 622 superimposed with the waveform of OFDM sequence 624. In some examples, a cyclic prefix (CP) 640 may be appended to the beginning of OFDM symbol 630 to create a guard interval between successive symbols. For example, the CP 640 may include a copy of the last portion of the OFDM symbol 630, such as the portion 626 of the waveform for OFDM sequence 624, which is copied (e.g., at 642) to the beginning of OFDM symbol 630.

However, in some examples, the transmitted signal may experience the issue of multipath (or multipath propagation), where the transmitted signal reaches the receiver through multiple paths at different times. This may occur due to, for example, environmental factors such as reflections, diffractions, and scattering caused by buildings, walls, vehicles, or terrain. When the transmission of an OFDM symbol that includes multiple overlaid sequences (e.g., two or more overlaid sequences), such as the OFDM symbol 630, undergoes multipath propagation, multiple overlaid sequences (e.g., overlaid sequence 610, 620) in the OFDM symbols (e.g., OFDM symbol 630) may cause interference with each other. For example, due to the delay between signals received via different paths, the ending portion of the second overlaid sequence within an OFDM symbol (e.g., the portion 626 in CP 640), which is copied to the beginning of the OFDM symbol as a CP (e.g., CP 640), may overlap with the beginning of the first overlaid sequence (e.g., overlaid sequence 610) received via another path. This overlap can cause the two sequences to mix, leading to interference.

In some aspects, to address the possible interference between the overlaid sequences caused by the CP (e.g., CP 640), which may be referred to as the “CP issue,” intervals of zeros may be added before and after the overlaid sequences. FIG. 6B is a diagram 650 illustrating an example of zero regions added before the beginning and after the end of the overlaid sequences in accordance with various aspects of the present disclosure.

As shown in FIG. 6B, to address the CP issue, in one configuration, the overlaid sequence can be generated by adding a total of (N₁+N₂) zeros before the beginning and after the end of the sequence of multiple overlaid sequences. For example, as shown in FIG. 6B, an interval (or gap) of N₁ zeros (e.g., interval 652) may be added before the beginning of one or more overlaid sequences (e.g., overlaid sequence 660), and an interval (or gap) of N₂ zeros (e.g., interval 654) may be added after the end of one or more overlaid sequences (e.g., overlaid sequence 670) of the OFDM symbol 680 when the OFDM symbol 680 is transmitted, so that a total of (N₁+N₂) zeros are added at the beginning and the end of the OFDM symbol 680.

In some examples, the one or more overlaid sequences may include: the first overlaid sequence of the entire WUS, the first overlaid sequence in each OOK “On” symbol, the first overlaid sequence in each OFDM symbol, the last overlaid sequence of the entire LP-WUS, the last overlaid sequence in each OOK “On” symbol, the last overlaid sequence in each OFDM symbol, and/or any other overlaid sequence within the LP-WUS.

This configuration creates intervals (or gaps) of zeros between the second overlaid sequence (e.g., overlaid sequence 670) and the first overlaid sequence (e.g., overlaid sequence 660) in the OFDM symbol 680, where the length of the interval (or gap) equals N₁+N₂. Since the CP duration (e.g., the duration of CP 690) is defined to be sufficiently long to counteract the effects of the multipath propagation, if N₁+N₂ is equal to or greater than the CP duration (e.g., the duration of CP 690), the first and second overlaid sequences will not mix after multipath propagation. In the example of FIG. 6B, the length of N₁+N₂ may be the length of gap 694 since the interval 654 (with the length of N₂) may be copied to the front of the OFDM symbol 680 as the CP.

In some examples, a total of (N₁+N₂) zeros may be added before the beginning and after the end of each overlaid sequence in the OFDM symbol. For example, referring to FIG. 6B, an interval (or gap) of N₁ zeros (e.g., interval 652) and an interval (or gap) of N₂ zeros (e.g., interval 656) may be respectively added before the beginning and after the end of the first overlaid sequence (e.g., overlaid sequence 660) of the OFDM symbol 680, and an interval (or gap) of N₁ zeros (e.g., interval 658) and an interval (or gap) of N₂ zeros (e.g., interval 654) may be respectively added before the beginning and after the end of the second overlaid sequence (e.g., overlaid sequence 670) of the OFDM symbol 680.

In some aspects, the number of zeros added before the beginning and after the end of the overlaid sequence (e.g., the values of N₁ and N₂) may be determined based on various conditions or needs. In some examples, the total number of zeros before the beginning and after the end of the overlaid sequences may at least equal to the number of samples in the CP. That is: N₁+N₂=N_{cp}, where N_{cp} is the number of samples in the CP (e.g., CP 690). In some examples, the length of the overlaid sequence Nₛ (e.g., the length of 674) may equal Nₒ−N_{cp}, where Nₒ is the On duration (e.g., the duration of a high-voltage signal) in the OOK waveform, such as the duration of 672.

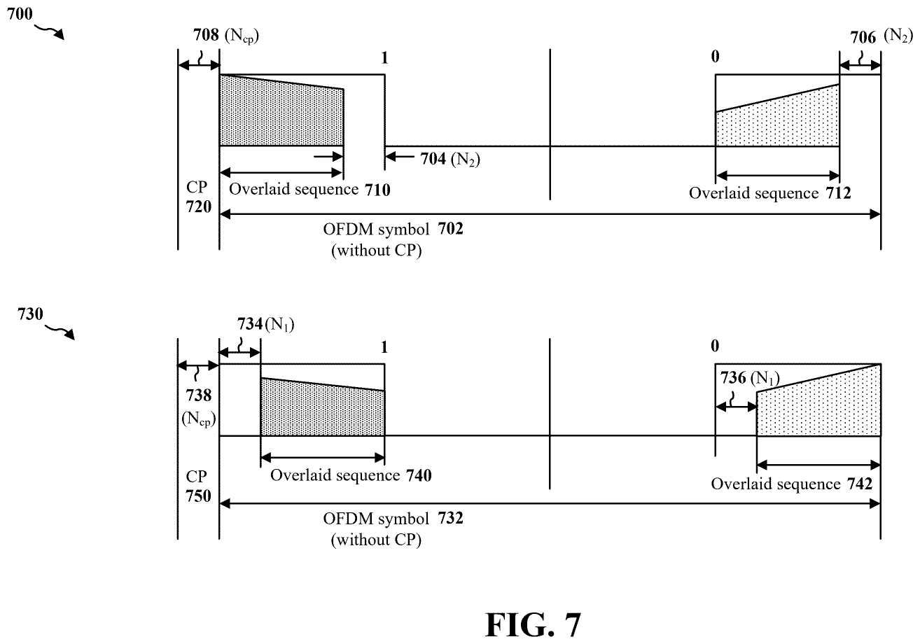

In some examples, the values of N₁ and N₂, representing the number of zeros before the beginning and after the end of the overlaid sequence, respectively, may be selected from one of the several options. FIG. 7 shows diagrams illustrating various options for the number of zeros added to the overlaid sequences in accordance with various aspects of the present disclosure. As shown in FIG. 7, in one configuration shown in diagram 700, the number of zeros added before the beginning of the overlaid sequence (e.g., overlaid sequence 710, 712) in OFDM symbol 702 may be zero (i.e., N₁=0), and the number of zeros added after the end of the overlaid sequence (e.g., overlaid sequence 710, 712) in OFDM symbol 702, such as N₂ for interval 704, 706, may equal to the duration of interval 708 (e.g., N_{cp}) of CP 720 (e.g., N₂=N_{cp}). This configuration of the values of N₁ and N₂ (i.e., N₁=0, and N₂=N_{cp}) may also be used to reduce or eliminate the interference between the OFDM symbols, such as OFDM symbol 702 and its adjacent OFDM symbols. In another configuration shown in diagram 730, the number of zeros added after the end of the overlaid sequence (e.g., overlaid sequence 740, 742) in OFDM symbol 732 may be zero (i.e., N₂=0), and the number of zeros added before the beginning of the overlaid sequence (e.g., overlaid sequence 740, 742), such as N₁ for interval 734, 736, may equal to the duration of interval 738 (e.g., N_{cp}) of CP 750 (e.g., N₁=N_{cp}). In some examples, referring to FIG. 6B, the number of zeros added before the beginning of the overlaid sequence (e.g., overlaid sequence 660, 670), such as N₁ for interval 652, 658, may be the largest integer that is less than half of the duration of the CP 690

$$( i . e . , {N}_{1} = ⌊ \frac{{N}_{CP}}{2} ⌋ ) ,$$

and the number of zeros added after the end of the overlaid sequence (e.g., overlaid sequence 660, 670), such as N₂ for interval 654, 656, may equal to the difference between N_{cp} and N₁ (e.g., N₂=N_{cp}−N₁). In some examples, referring to FIG. 6B, the number of zeros added after the end of the overlaid sequence (e.g., overlaid sequence 660, 670), such as N₂ for interval 654, 656, may be the largest integer less than half of the duration CP 690

$$( i . e . , {N}_{2} = ⌊ \frac{{N}_{CP}}{2} ⌋ ) ,$$

and the number of zeros added before the beginning of the overlaid sequence (e.g., overlaid sequence 660, 670), such as N₁ for interval 652, 658, may equal to the difference between N_{cp} and N₂ (e.g., N₁=N_{cp}−N₂).

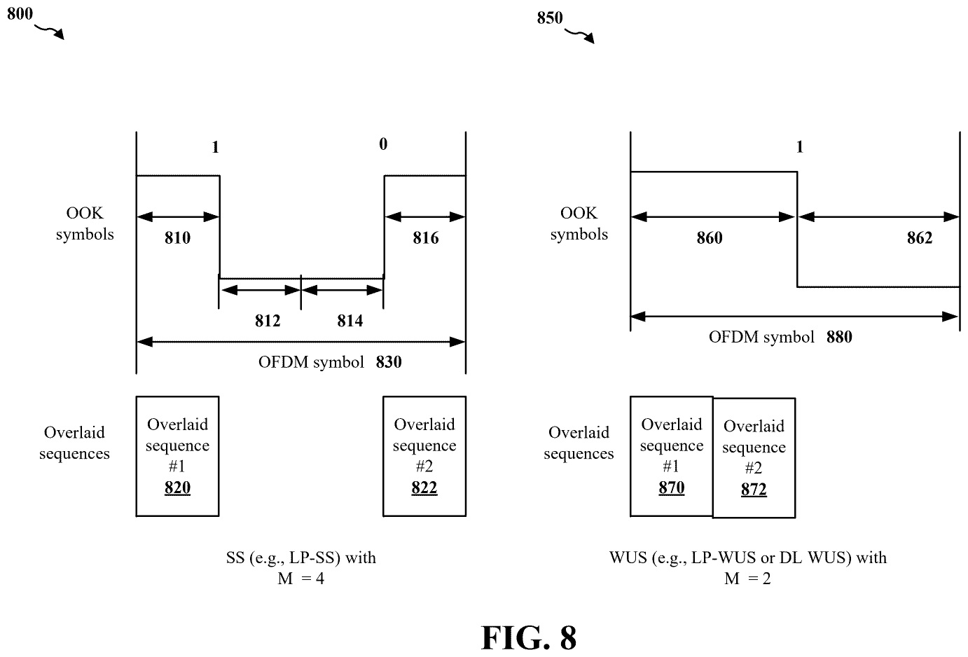

In some aspects, it is beneficial to use a larger value of OOK symbols per OFDM symbol (e.g., M) for SS (e.g., an LP-SS) to achieve better timing synchronization accuracy because a larger M provides more edges (i.e., low-to-high and high-to-low) to facilitate timing synchronization. On the other hand, using a larger number of OOK symbols per OFDM symbol (e.g., M) for a WUS (e.g., an LP-WUS or a DL WUS) has a higher timing synchronization burden for reliable detection because a larger M corresponds to a narrower OOK symbol duration. As a result, a WUS and an SS (e.g., an LP-SS) may be configured with different values of M. For example, a larger M may be configured for the SS, and a smaller M may be configured for WUS. FIG. 8 shows diagrams illustrating the examples of overlaid sequences for a WUS (e.g., an LP-WUS or a DL WUS) and an SS (e.g., an LP-SS) in accordance with various aspects of the present disclosure. As shown in FIG. 8, in diagram 800, there are four OOK symbols (e.g., OOK symbols 810, 812, 814, 816) in OFDM symbol 830. Hence M=4. In diagram 850, there are two OOK symbols (e.g., OOK symbols 860, 862) in OFDM symbol 880. Hence M=2.

When a single overlaid sequence is transmitted during each OOK “On” symbol (e.g., OOK symbol 512, 524) for both WUS and SS, the difference in M values results in varying overlaid sequence lengths for WUS and SS. This variation can complicate UE implementation, as the UE may need to generate, store, and utilize different sets of overlaid sequences to receive the WUS and SS.

In some aspects, to avoid the variation in the lengths of the overlaid sequence for WUS (e.g., LP-WUS or DL WUS) and SS (e.g., LP-SS), when the value of M for an SS is larger than the value of M for a WUS, the overlaid sequence length may be determined based on the value of M for an SS. As shown in FIG. 8, in diagram 800, the value M is four for an SS. For example, for an SS, four OOK symbols, such as OOK symbols 810, 812, 814, 816, may be included in an OFDM symbol, such as OFDM symbol 830. In diagram 850, the value of Mis two for a WUS. For example, for a WUS, two OOK symbols, such as OOK symbols 860, 862, may be included in an OFDM symbol, such as OFDM symbol 880, for a WUS. For an SS (e.g., an LP-SS), one overlaid sequence may be transmitted during each OOK “On” symbol duration. For example, in diagram 800, overlaid sequence #1 820 may be transmitted during OOK symbol 810, and overlaid sequence #2 822 may be transmitted during OOK symbol 816, for an SS. On the other hand, for a WUS, two overlaid sequences may be transmitted during each OOK “On” symbol duration. For example, in diagram 850, overlaid sequence #1 870 and overlaid sequence #2 872 may be transmitted during OOK symbol 860 for a WUS.

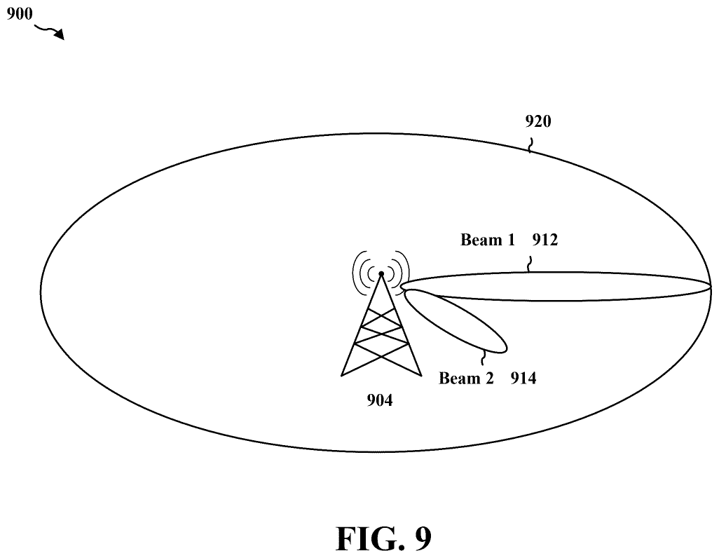

In some aspects, the support for overlaid sequence-based WUS may be configured by broadcast information, such as that included in the system information block (SIB). In some aspects, the network may not necessarily transmit WUS (e.g., LP-WUS or DL WUS) and SS (e.g., LP-SS) using beams that cover the cell edge, due to the more limited coverage range of WUS and SS compared to the PDCCH. FIG. 9 is a diagram 900 illustrating various beams for WUS (e.g., LP-WUS or DL WUS) and SS (e.g., LP-SS) transmissions in accordance with various aspects of the present disclosure. For example, referring to FIG. 9, in some aspects, the network (e.g., base station 904) may not necessarily transmit WUS and SS using beams that cover the edge of the cell coverage range 920, such as beam 1 912, due to the more limited coverage range of WUS and SS compared to the PDCCH. Instead, the network (e.g., base station 904) may transmit WUS and SS using beams that cover the interior of cell coverage range 920, such as beam 2 914. This limited coverage issue may primarily affect OOK-modulated WUS and not overlaid sequence-based WUS. Therefore, the decision on whether WUS (e.g., LP-WUS or DL WUS) and SS (e.g., LP-SS) are transmitted using a subset of SSB beams or all SSB beams within the cell may depend on whether the cell supports overlaid sequence-based WUS. For example, as shown in FIG. 9, if the cell (e.g., base station 904) supports overlaid sequence-based WUS, the cell (e.g., base station 904) may transmit WUS and SS using all SSB beams within the cell (e.g., base station 904), including beam 1 912 and beam 2 914. On the other hand, if the cell (e.g., base station 904) does not support overlaid sequence-based WUS, the cell (e.g., base station 904) may transmit WUS and SS using a subset of SSB beams within the cell (e.g., base station 904). For example, the subset of SSB beams may include beams that cover the interior of the coverage range 920, such as beam 2 914, but not include beams that cover the edge of the coverage range 920, such as beam 1 912.

FIG. 9 is a diagram 900 illustrating various beams for WUS (e.g., LP-WUS or DL WUS) and SS (e.g., LP-SS) transmissions in accordance with various aspects of the present disclosure. As shown in FIG. 9, if the network, such as base station 904, supports overlaid sequence-modulated WUS and SS, as determined by network configuration, WUS and SS may be transmitted across all SSB beams within the cell. On the other hand, if an overlaid sequence-based WUS is not supported by the network (e.g., base station 904), WUS and SS may be transmitted in a subset of the SSB beams. This configuration determines whether the information for the subset of SSB beams is included or absent in the WUS (or SS) configuration.

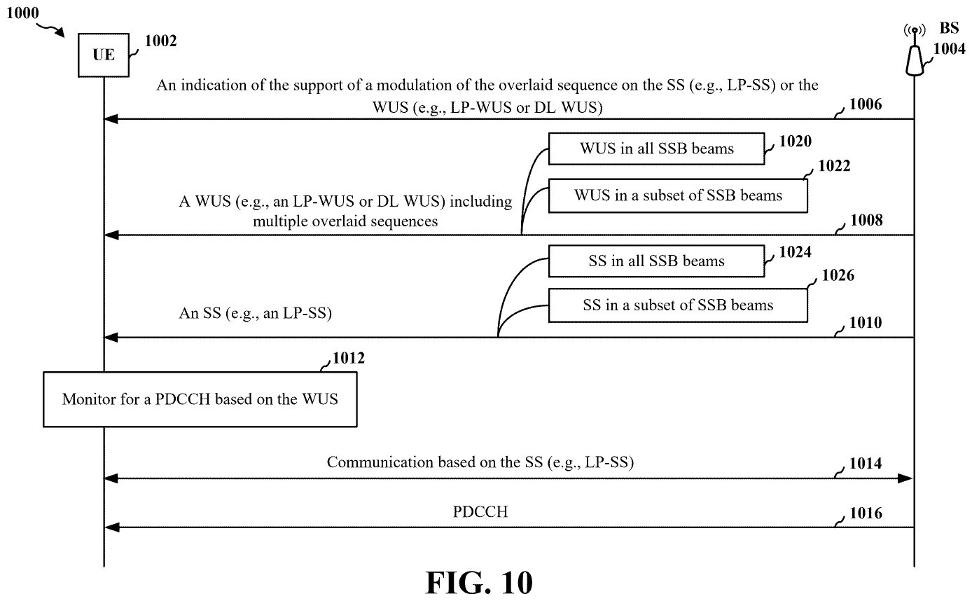

FIG. 10 is a call flow diagram 1000 illustrating a method of wireless communication in accordance with various aspects of this present disclosure. Various aspects are described in connection with a UE 1002 and a base station 1004. The aspects may be performed by the UE 1002 or the base station 1004 in aggregation and/or by one or more components of a base station 1004 (e.g., a CU 110, a DU 130, and/or an RU 140).

As shown in FIG. 10, at 1006, the UE 1002 may receive an indication of the support of the modulation of the overlaid sequence on the SS (e.g., LP-SS) or the WUS (e.g., an LP-WUS or a DL WUS) from base station 1004. In some examples, the indication may indicate whether the base station 1004 supports the modulation of the overlaid sequence on the SS (e.g., LP-SS), such as the modulation of overlaid sequence #1 820 and overlaid sequence #2 822 on OOK symbols 810 and 816 on an SS (e.g., an LP-SS). In some examples, the indication may indicate whether the base station 1004 supports the modulation of the overlaid sequence on the WUS, such as the modulation of overlaid sequence #1 870 and overlaid sequence #2 872 on OOK symbol 860 on a WUS (e.g., an LP-WUS or a DL WUS).

At 1008, the UE 1002 may receive a WUS (e.g., an LP-WUS or a DL WUS) from base station 1004. The WUS may include multiple overlaid sequences. For example, referring to FIG. 6B, the WUS may include overlaid sequence 660, and overlaid sequence 670. The WUS includes a first zero interval (e.g., interval 652) adjacent to the beginning of one or more overlaid sequences (e.g., overlaid sequence 660) of the multiple overlaid sequences. The WUS may further include a second zero interval (e.g., interval 654) adjacent to the end of one or more overlaid sequences (e.g., overlaid sequence 670) of the multiple overlaid sequences. For example, referring to FIG. 6B, since the zero intervals may be added before the beginning of the first overlaid sequence, or after the end of the last overlaid sequence, or both, the interference between the overlaid sequences (e.g., between overlaid sequence 660, 670) in multipath propagation may be reduced or eliminated.

In some examples, the one or more overlaid sequences may include: the first overlaid sequence of the entire WUS, the first overlaid sequence in each OOK “On” symbol, the first overlaid sequence in each OFDM symbol, the last overlaid sequence of the entire WUS, the last overlaid sequence in each OOK “On” symbol, the last overlaid sequence in each OFDM symbol, and/or any other overlaid sequence within the WUS.

In some aspects, based on whether the base station 1004 supports the modulation of the overlaid sequence on the WUS, the UE 1002 may receive the WUS in a subset of synchronization signal block (SSB) beams or all SSB beams of the base station 1004. For example, if the base station 1004 supports the modulation of the overlaid sequence on the WUS, the UE 1002 may, at 1020, receive the WUS in all SSB beams (for transmitted SSBs) of the base station 1004. On the other hand, if the base station 1004 does not support the modulation of the overlaid sequence on the WUS, the UE 1002 may, at 1022, receive the WUS in a subset of SSB beams (for transmitted SSBs) of the base station 1004.

At 1010, the UE 1002 may receive a WUS (e.g., an LP-WUS or a DL WUS) from base station 1004. In some aspects, the SS (e.g., the LP-SS) has a first number of OOK symbols per OFDM symbol, and the first number of OOK symbols is different from a second number of OOK symbols per OFDM symbol in a WUS (e.g., an LP-WUS or a DL WUS). For example, referring to FIG. 8, in diagram 800, the SS (e.g., the LP-SS) has four OOK symbols (e.g., OOK symbols 810, 812, 814, 816) per OFDM symbol (e.g., in OFDM symbol 830). In diagram 850, the WUS has a second number of OOK symbols (e.g., two OOK symbols, such as OOK symbols 860, 862) per OFDM symbol (e.g., in OFDM symbol 880), which is different from the first number of OOK symbols (e.g., four OOK symbols).

In some aspects, based on whether the base station 1004 supports the modulation of the overlaid sequence on the SS, the UE 1002 may receive the SS in a subset of SSB beams or all SSB beams (for transmitted SSBs) of the base station 1004. For example, if the base station 1004 supports the modulation of the overlaid sequence on the SS, the UE 1002 may, at 1024, receive the SS in all SSB beams (for transmitted SSBs) of the base station 1004. On the other hand, if the base station 1004 does not support the modulation of the overlaid sequence on the SS, the UE 1002 may, at 1026, receive the SS in a subset of SSB beams (for transmitted SSBs) of the base station 1004.

At 1012, the UE 1002 may monitor for a PDCCH based on the WUS (e.g., the WUS received at 1008). For example, referring to FIG. 4, when the LP-WUR 402 of the UE 1002 detects the WUS, the UE 1002 may activate the MR 404 to monitor the PDCCH.

At 1014, the UE 1002 may communicate with the base station 1004 based on the SS (e.g., the SS received at 1010).

At 1016, the base station 1004 may transmit a PDCCH to UE 1002. Since the UE 1002 is monitoring for a PDCCH at 1012, the UE 1002 may successfully detect the PDCCH.

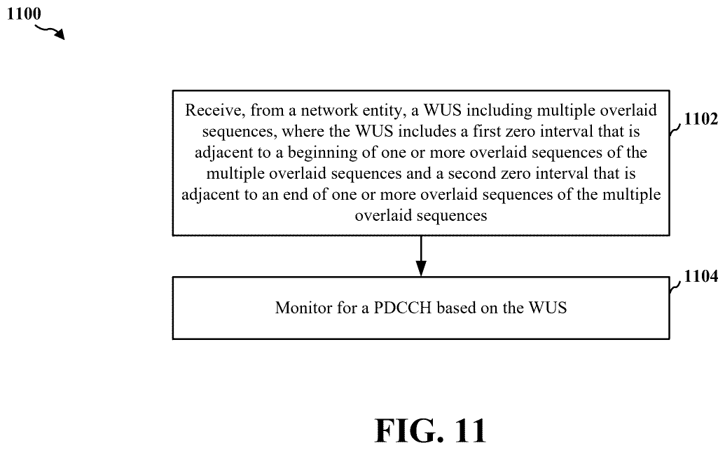

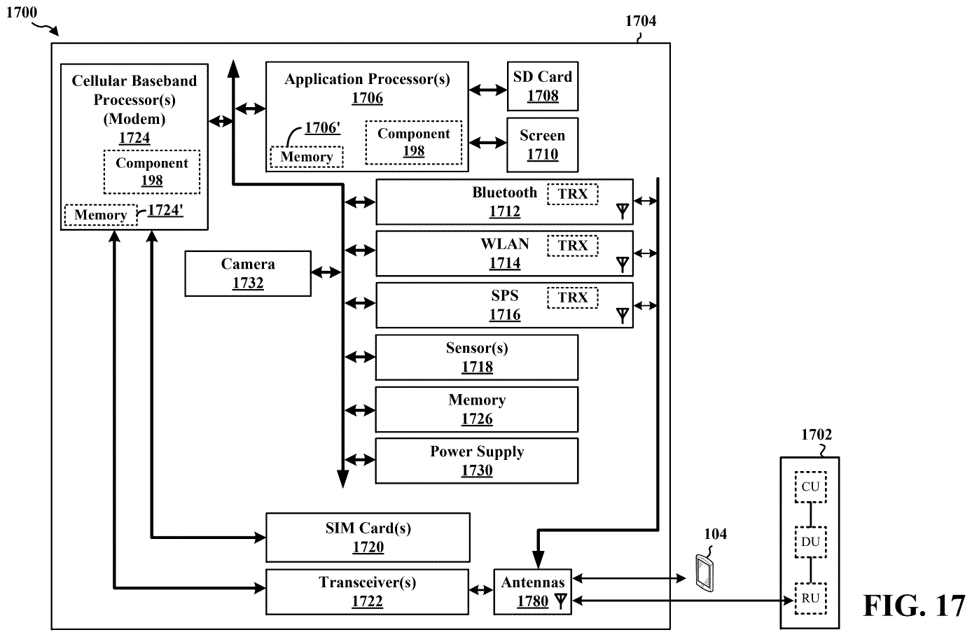

FIG. 11 is a flowchart 1100 illustrating methods of wireless communication at a UE in accordance with various aspects of the present disclosure. The method may be performed by a UE in collaboration with a network entity. The network entity may be a base station, or a component of a base station, in the access network of FIG. 1 or a core network component (e.g., base station 102, 310, 904, 1004; or the network entity 1702 in the hardware implementation of FIG. 17). The UE may be the UE 104, 350, 1002, or the apparatus 1704 in the hardware implementation of FIG. 17. By introducing intervals of zeros (or gaps of zeros) before and after overlaid sequences, the methods prevent mixing of these sequences in multipath propagations, thereby minimizing interference between the overlaid sequences and ensuring reliable wakeup detection. Additionally, by enabling the configuration of different numbers of OOK symbols (or information bits) in an OFDM symbol for WUS and SS, the methods improve synchronization accuracy and detection reliability under various operational conditions. In some examples, by supporting WUS and SS transmissions in all or a subset of SSB beams based on network configuration, the methods ensure efficient resource utilization for varying network capabilities and coverage conditions.

As shown in FIG. 11, at 1102, the UE may receive a WUS (e.g., an LP-WUS or a DL WUS) including multiple overlaid sequences from a network entity. The WUS may include a first zero interval that is adjacent to the beginning of one or more overlaid sequences of the multiple overlaid sequences and a second zero interval that is adjacent to the end of one or more overlaid sequences of the multiple overlaid sequences. FIG. 6B, FIG. 7, FIG. 8, FIG. 9, and FIG. 10 illustrate various aspects of the steps in connection with flowchart 1100. For example, referring to FIG. 10, the UE 1002 may, at 1008, receive a WUS (e.g., an LP-WUS or a DL WUS) from a network entity (e.g., base station 1004). Referring to FIG. 6B, the WUS may include multiple overlaid sequences (e.g., overlaid sequence 660, 670). The WUS may include a first zero interval (e.g., interval 652) adjacent to the beginning of one or more overlaid sequences (e.g., overlaid sequence 660) of the multiple overlaid sequences and a second zero interval (e.g., interval 654) adjacent to the end of one or more overlaid sequences (e.g., overlaid sequence 670) of the multiple overlaid sequences. In some examples, the one or more overlaid sequences may include: the first overlaid sequence of the entire WUS, the first overlaid sequence in each OOK “On” symbol, the first overlaid sequence in each OFDM symbol, the last overlaid sequence of the entire WUS, the last overlaid sequence in each OOK “On” symbol, the last overlaid sequence in each OFDM symbol, and/or any other overlaid sequence within the WUS. In some aspects, 1102 may be performed by the sequence reception component 198.

In some examples, the overlaid sequence may also apply to the SS. For example, during each OOK “On” symbol duration (e.g., at 810, 816, 860), one or multiple overlaid sequences may be transmitted sequentially. For example, referring to FIG. 8, in diagram 850, multiple overlaid sequences (e.g., overlaid sequence #1 850 and overlaid sequence #2 870) may be transmitted within an OOK “On” symbol (e.g., at 860).

At 1104, the UE may monitor for a physical downlink control channel (PDCCH) based on the WUS. For example, referring to FIG. 10, the UE 1002 may, at 1012, monitor for a PDCCH based on the WUS. In some aspects, 1104 may be performed by the sequence reception component 198.

In some aspects, the sum of the first zero interval and the second zero interval is greater than or equal to the CP duration of the WUS. For example, referring to FIG. 6B, the sum of the first zero interval (e.g., interval 652) and the second zero interval (e.g., interval 654) is greater than or equal to the CP duration of the WUS (e.g., duration of CP 690).

In some aspects, the WUS may include the first zero interval that is adjacent to the beginning of two or more overlaid sequences of the multiple overlaid sequences, and the WUS may further include the second zero interval that is adjacent to the end of the two or more overlaid sequences of the multiple overlaid sequences. For example, referring to FIG. 6B, the WUS may include the first zero interval (e.g., interval 652, 658) adjacent to the beginning of two or more overlaid sequences (e.g., overlaid sequence 660, 670) of the multiple overlaid sequences, and the WUS may further include the second zero interval (e.g., interval 656, 654) adjacent to the end of the two or more overlaid sequences (e.g., overlaid sequence 660, 670) of the multiple overlaid sequences.

In some aspects, a first length of the first zero interval may be N₁, a second length of the second zero interval may be N₂, and a third length of the CP duration is N_{cp}. The values of N₁, N₂, and N_{cp} may be one of the following combinations: N₁=0, N₂=N_{cp}, or N₁=N_{cp}, N₂=0, N₁=└N_{cp}/2┘, N₂=N_{cp}−N₁, or N₁=N_{cp}−N₂, N₂=└N_{cp}/2┘. For example, referring to FIG. 7, in diagram 700, there is no first zero interval before each overlaid sequence (i.e., the length of the first zero interval is zero), and the length of second zero interval (e.g., interval 704, 706) may be N₂, which may equal the length of CP 720 (N_{cp}). In diagram 730, there is no second zero interval after each overlaid sequence (i.e., the length of the second zero interval is zero), and the length of the first zero interval (e.g., interval 734, 736) may be N₁, which may equal the length of CP 750 (N_{cp}). Referring to FIG. 6B, the length of the first zero interval (e.g., interval 652, 658) is N₁, and the length of the second zero interval (e.g., interval 656, 654) is N₂. In one configuration, N₁=└N_{cp}/2┘, N₂=N_{cp}−N₁. In another configuration, N₂= └N_{cp}/2┘, N₁=N_{cp}−N₂.

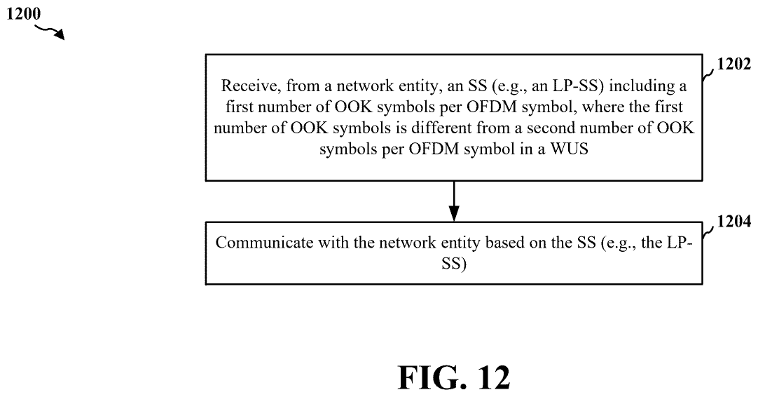

FIG. 12 is a flowchart 1200 illustrating methods of wireless communication at a UE in accordance with various aspects of the present disclosure. The method may be performed by a UE in collaboration with a network entity. The network entity may be a base station, or a component of a base station, in the access network of FIG. 1 or a core network component (e.g., base station 102, 310, 904, 1004; or the network entity 1702 in the hardware implementation of FIG. 17). The UE may be the UE 104, 350, 1002, or the apparatus 1704 in the hardware implementation of FIG. 17. By introducing intervals of zeros (or gaps of zeros) before and after overlaid sequences, the methods prevent mixing of these sequences in multipath propagations, thereby minimizing interference between the overlaid sequences and ensuring reliable wakeup detection. Additionally, by enabling the configuration of different numbers of OOK symbols (or information bits) in an OFDM symbol for WUS and SS, the methods improve synchronization accuracy and detection reliability under various operational conditions. In some examples, by supporting WUS and SS transmissions in all or a subset of SSB beams based on network configuration, the methods ensure efficient resource utilization for varying network capabilities and coverage conditions.

As shown in FIG. 12, at 1102, the UE may receive an SS (e.g., an LP-SS) from a network entity. The SS may have a first number of OOK symbols per OFDM symbol, and the first number of OOK symbols may be different from a second number of OOK symbols per OFDM symbol in an WUS. FIG. 6B, FIG. 7, FIG. 8, FIG. 9, and FIG. 10 illustrate various aspects of the steps in connection with flowchart 1200. For example, referring to FIG. 10, the UE 1002 may, at 1010, receive an SS (e.g., an LP-SS) from a network entity (e.g., base station 1004). Referring to FIG. 8, in diagram 800, the SS may have a first number (e.g., four) of OOK symbols per OFDM symbol (e.g., OFDM symbol 830), and the first number of OOK symbols may be different from a second number (e.g., two) of OOK symbols per OFDM symbol (e.g., OFDM symbol 880) in a WUS (e.g., an LP-WUS or a DL WUS) in diagram 850. In some aspects, 1202 may be performed by the sequence reception component 198.

At 1204, the UE may communicate with the network entity based on the SS (e.g., the LP-SS). For example, referring to FIG. 10, the UE 1002 may, at 1014, communicate with the network entity (e.g., base station 1004) based on the SS. In some aspects, 1204 may be performed by the sequence reception component 198.

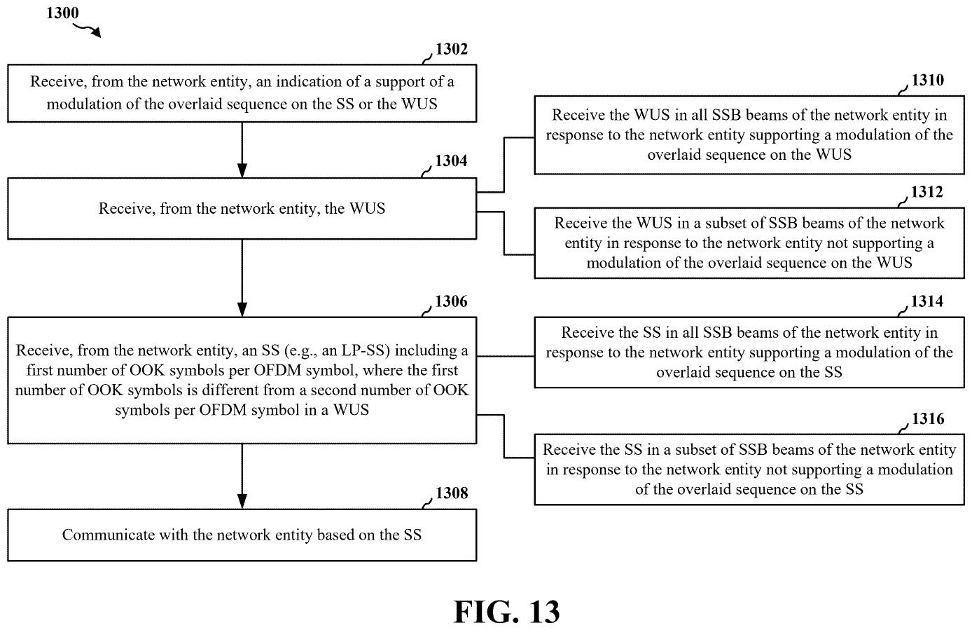

FIG. 13 is a flowchart 1300 illustrating methods of wireless communication at a UE in accordance with various aspects of the present disclosure. The method may be performed by a UE in collaboration with a network entity. The network entity may be a base station, or a component of a base station, in the access network of FIG. 1 or a core network component (e.g., base station 102, 310, 904, 1004; or the network entity 1702 in the hardware implementation of FIG. 17). The UE may be the UE 104, 350, 1002, or the apparatus 1704 in the hardware implementation of FIG. 17. By introducing intervals of zeros (or gaps of zeros) before and after overlaid sequences, the methods prevent mixing of these sequences in multipath propagations, thereby minimizing interference between the overlaid sequences and ensuring reliable wakeup detection. Additionally, by enabling the configuration of different numbers of OOK symbols (or information bits) in an OFDM symbol for WUS and SS, the methods improve synchronization accuracy and detection reliability under various operational conditions. In some examples, by supporting WUS and SS transmissions in all or a subset of SSB beams based on network configuration, the methods ensure efficient resource utilization for varying network capabilities and coverage conditions.

As shown in FIG. 13, at 1306, the UE may receive an SS (e.g., an LP-SS) from a network entity. The SS may have a first number of OOK symbols per OFDM symbol, and the first number of OOK symbols may be different from a second number of OOK symbols per OFDM symbol in a WUS (e.g., an LP-WUS or a DL WUS). FIG. 6B, FIG. 7, FIG. 8, FIG. 9, and FIG. 10 illustrate various aspects of the steps in connection with flowchart 1300. For example, referring to FIG. 10, the UE 1002 may, at 1010, receive an SS (e.g., an LP-SS) from a network entity (e.g., base station 1004). Referring to FIG. 8, in diagram 800, the SS may have a first number (e.g., four) of OOK symbols per OFDM symbol, and the first number of OOK symbols may be different from a second number (e.g., two) of OOK symbols per OFDM symbol in a WUS in diagram 850. In some aspects, 1306 may be performed by the sequence reception component 198.

At 1308, the UE may communicate with the network entity based on the SS (e.g., the LP-SS). For example, referring to FIG. 10, the UE 1002 may, at 1014, communicate with the network entity (e.g., base station 1004) based on the SS. In some aspects, 1308 may be performed by the sequence reception component 198.

In some aspects, at 1304, the UE may receive the WUS from the network entity. Each of the SS and the WUS may include multiple overlaid sequences. For example, referring to FIG. 10, the UE 1002 may, at 1008, receive the WUS from the network entity (e.g., base station 1004). Referring to FIG. 8, in diagram 800, the SS may include multiple overlaid sequences (e.g., overlaid sequence #1 820, overlaid sequence #1 822). In diagram 850, the WUS may include multiple overlaid sequences (e.g., overlaid sequence #1 870, overlaid sequence #2 872). In some aspects, 1304 may be performed by the sequence reception component 198.

In some aspects, the SS may have a larger number of OOK symbols per OFDM symbol than the WUS. That is, the first number may be greater than the second number. In that case, the length of the overlaid sequences is based on the number of OOK symbols per OFDM symbol for the SS (i.e., the first number). For example, referring to FIG. 8, the first number may be four (e.g., four OOK symbols in OFDM symbol 830), and the second number may be two (e.g., two OOK symbols in OFDM symbol 880). The first number (e.g., four) is greater than the second number (e.g., two), and the length of the overlaid sequences is based on the first number (e.g., four).

In some aspects, the WUS may have a larger number of OOK symbols per OFDM symbol than the SS. That is, the second number may be greater than the first number. In that case, the length of the overlaid sequences is based on the number of OOK symbols per OFDM symbol for the WUS (i.e., the second number). In some aspects, the length of the overlaid sequences for the WUS may be the same as the length of the overlaid sequences for the SS.

In some aspects, at 1314, the UE may receive the SS in all SSB beams of the network entity if the network entity supports the modulation of the overlaid sequence on the SS. For example, referring to FIG. 10, the UE 1002 may, at 1024, receive the SS in all SSB beams of the network entity (e.g., base station 1004) if the network entity (e.g., base station 1004) supports the modulation of the overlaid sequence on the SS. The SSB beams may correspond to transmitted SSBs. In some aspects, 1314 may be performed by the sequence reception component 198.

In some aspects, at 1316, the UE may receive the SS in a subset of SSB beams of the network entity if the network entity does not support the modulation of the overlaid sequence on the SS. For example, referring to FIG. 10, the UE 1002 may, at 1026, receive the SS in a subset of SSB beams of the network entity (e.g., base station 1004) if the network entity (e.g., base station 1004) does not support the modulation of the overlaid sequence on the SS. The subset of SSB beams may correspond to transmitted SSBs. In some aspects, 1316 may be performed by the sequence reception component 198.

In some aspects, at 1310, the UE may receive the WUS in all SSB beams of the network entity if the network entity supports the modulation of the overlaid sequence on the WUS. For example, referring to FIG. 10, the UE 1002 may, at 1020, receive the WUS in all SSB beams of the network entity (e.g., base station 1004) if the network entity (e.g., base station 1004) supports the modulation of the overlaid sequence on the WUS. The SSB beams may correspond to transmitted SSBs. In some aspects, 1310 may be performed by the sequence reception component 198.

In some aspects, at 1312, the UE may receive the WUS in a subset of SSB beams of the network entity if the network entity does not support the modulation of the overlaid sequence on the WUS. For example, referring to FIG. 10, the UE 1002 may, at 1022, receive the WUS in a subset of SSB beams of the network entity (e.g., base station 1004) if the network entity (e.g., base station 1004) does not support the modulation of the overlaid sequence on the WUS. The subset of SSB beams may correspond to transmitted SSBs. In some aspects, 1312 may be performed by the sequence reception component 198.

In some aspects, at 1302, the UE may receive, from the network entity, an indication of a support of the modulation of the overlaid sequence on the SS or the WUS. For example, referring to FIG. 10, the UE 1002 may, at 1006, receive, from the network entity (e.g., base station 1004), an indication of a support of the modulation of the overlaid sequence on the SS or the WUS. In some aspects, 1302 may be performed by the sequence reception component 198.

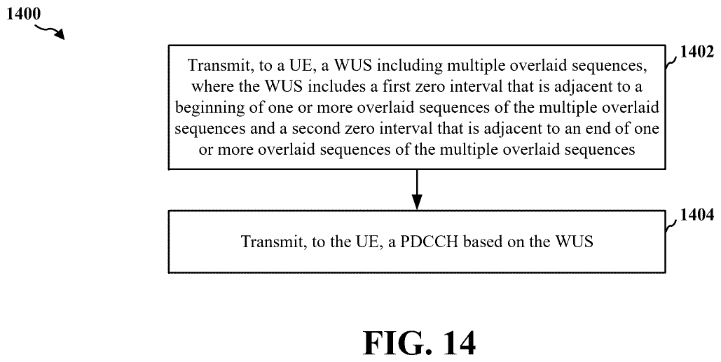

FIG. 14 is a flowchart 1400 illustrating methods of wireless communication at a network entity in accordance with various aspects of the present disclosure. The method may be performed by a network entity in collaboration with a UE. The network entity may be a base station, or a component of a base station, in the access network of FIG. 1 or a core network component (e.g., base station 102, 310, 904, 1004; or the network entity 1702 in the hardware implementation of FIG. 17). The UE may be the UE 104, 350, 1002, or the apparatus 1704 in the hardware implementation of FIG. 17. By introducing intervals of zeros (or gaps of zeros) before and after overlaid sequences, the methods prevent mixing of these sequences in multipath propagations, thereby minimizing interference between the overlaid sequences and ensuring reliable wakeup detection. Additionally, by enabling the configuration of different numbers of OOK symbols (or information bits) in an OFDM symbol for WUS and SS, the methods improve synchronization accuracy and detection reliability under various operational conditions. In some examples, by supporting WUS and SS transmissions in all or a subset of SSB beams based on network configuration, the methods ensure efficient resource utilization for varying network capabilities and coverage conditions.

As shown in FIG. 14, at 1402, the network entity may transmit a WUS (e.g., an LP-WUS or a DL WUS) to a UE. The WUS may include multiple overlaid sequences. The WUS may further include a first zero interval that is adjacent to the beginning of one or more overlaid sequences of the multiple overlaid sequences and a second zero interval that is adjacent to the end of one or more overlaid sequences of the multiple overlaid sequences. FIG. 6B, FIG. 7, FIG. 8, FIG. 9, and FIG. 10 illustrate various aspects of the steps in connection with flowchart 1400. For example, referring to FIG. 10, the network entity (e.g., base station 1004) may, at 1008, transmit a WUS to a UE 1002. Referring to FIG. 6B, the WUS may include multiple overlaid sequences (e.g., overlaid sequence 660, 670). The WUS may include a first zero interval (e.g., interval 652) adjacent to the beginning of one or more overlaid sequences (e.g., overlaid sequence 660) of the multiple overlaid sequences and a second zero interval (e.g., interval 654) adjacent to the end of one or more overlaid sequences (e.g., overlaid sequence 670) of the multiple overlaid sequences. In some examples, the one or more overlaid sequences may include: the first overlaid sequence of the entire WUS, the first overlaid sequence in each OOK “On” symbol, the first overlaid sequence in each OFDM symbol, the last overlaid sequence of the entire WUS, the last overlaid sequence in each OOK “On” symbol, the last overlaid sequence in each OFDM symbol, and/or any other overlaid sequence within the WUS. In some aspects, 1402 may be performed by the sequence transmission component 199.

In some examples, the overlaid sequence may also apply to the SS (e.g., the LP-SS). For example, during each OOK “On” symbol duration (e.g., at 810, 816, 860), one or multiple overlaid sequences may be transmitted sequentially. For example, referring to FIG. 8, in diagram 850, multiple overlaid sequences (e.g., overlaid sequence #1 850 and overlaid sequence #2 870) may be transmitted within an OOK “On” symbol (e.g., at 860).

At 1404, the network entity may transmit, to the UE, a PDCCH based on the WUS. For example, referring to FIG. 10, the network entity (e.g., base station 1004) may, at 1016, transmit, to the UE 1002, a PDCCH based on the WUS. In some aspects, 1404 may be performed by the sequence transmission component 199.

In some aspects, the sum of the first zero interval and the second zero interval may be greater than or equal to the CP duration of the WUS. For example, referring to FIG. 6B, the sum of the first zero interval (e.g., interval 652) and the second zero interval (e.g., interval 654) is greater than or equal to the CP duration of the WUS (e.g., duration of CP 690).

In some aspects, the WUS may include the first zero interval that is adjacent to the beginning of two or more overlaid sequences of the multiple overlaid sequences, and the WUS may further include the second zero interval that is adjacent to the end of the two or more overlaid sequences of the multiple overlaid sequences. For example, referring to FIG. 6B, the WUS may include the first zero interval (e.g., interval 652, 658) adjacent to the beginning of two or more overlaid sequences (e.g., overlaid sequence 660, 670) of the multiple overlaid sequences, and the WUS may further include the second zero interval (e.g., interval 656, 654) adjacent to the end of the two or more overlaid sequences (e.g., overlaid sequence 660, 670) of the multiple overlaid sequences.

In some aspects, a first length of the first zero interval may be N₁, a second length of the second zero interval may be N₂, and a third length of the CP duration is N_{cp}. The values of N₁, N₂, and N_{cp} may be one of the following combinations: N₁=0, N₂=N_{cp}, or N₁=N_{cp}, N₂=0, N₁=└N_{cp}/2┘, N₂=N_{cp}-N₁, or N₁=N_{cp}−N₂, N₂=└N_{cp}/2┘. For example, referring to FIG. 7, in diagram 700, there is no first zero interval before each overlaid sequence (i.e., the length of the first zero interval is zero), and the length of second zero interval (e.g., interval 704, 706) may be N₂, which may equal the length of CP 720 (N_{cp}). In diagram 730, there is no second zero interval after each overlaid sequence (i.e., the length of the second zero interval is zero), and the length of the first zero interval (e.g., interval 734, 736) may be N₁, which may equal the length of CP 750 (N_{cp}). Referring to FIG. 6B, the length of the first zero interval (e.g., interval 652, 658) is N₁, and the length of the second zero interval (e.g., interval 656, 654) is N₂. In one configuration, N₁=└N_{cp}/2┘, N₂=N_{cp}−N₁. In another configuration, N₂= └N_{cp}/2┘, N₁=N_{cp}−N₂.

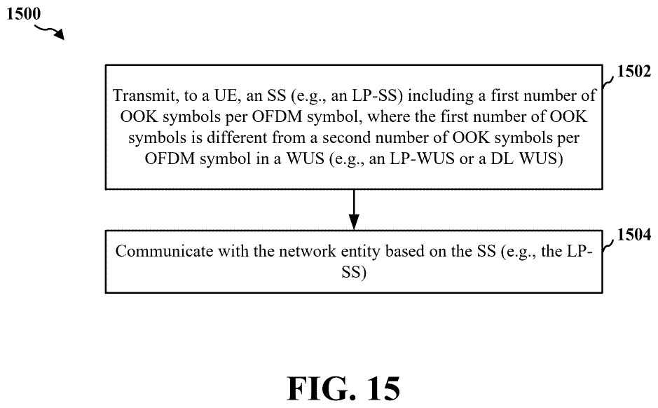

FIG. 15 is a flowchart 1500 illustrating methods of wireless communication at a network entity in accordance with various aspects of the present disclosure. The method may be performed by a network entity in collaboration with a UE. The network entity may be a base station, or a component of a base station, in the access network of FIG. 1 or a core network component (e.g., base station 102, 310, 904, 1004; or the network entity 1702 in the hardware implementation of FIG. 17). The UE may be the UE 104, 350, 1002, or the apparatus 1704 in the hardware implementation of FIG. 17. By introducing intervals of zeros (or gaps of zeros) before and after overlaid sequences, the methods prevent mixing of these sequences in multipath propagations, thereby minimizing interference between the overlaid sequences and ensuring reliable wakeup detection. Additionally, by enabling the configuration of different numbers of OOK symbols (or information bits) in an OFDM symbol for WUS and SS, the methods improve synchronization accuracy and detection reliability under various operational conditions. In some examples, by supporting WUS and SS transmissions in all or a subset of SSB beams based on network configuration, the methods ensure efficient resource utilization for varying network capabilities and coverage conditions.

As shown in FIG. 15, at 1502, the network entity may transmit, to a UE, an SS (e.g., an LP-SS). The SS may have a first number of OOK symbols per OFDM symbol. The first number of OOK symbols may be different from a second number of OOK symbols per OFDM symbol in a WUS (e.g., an LP-WUS or a DL WUS). FIG. 6B, FIG. 7, FIG. 8, FIG. 9, and FIG. 10 illustrate various aspects of the steps in connection with flowchart 1500. For example, referring to FIG. 10, the network entity (e.g., base station 1004) may, at 1014, transmit, to a UE 1002, an SS (e.g., an LP-SS). Referring to FIG. 8, in diagram 800, the SS may have a first number (e.g., four) of OOK symbols per OFDM symbol (e.g., OFDM symbol 830), and the first number of OOK symbols may be different from a second number (e.g., two) of OOK symbols per OFDM symbol (e.g., OFDM symbol 880) in a WUS in diagram 850. In some aspects, 1502 may be performed by the sequence transmission component 199.

At 1504, the network entity may communicate with the UE based on the SS (e.g., the LP-SS). For example, referring to FIG. 10, the network entity (e.g., base station 1004) may, at 1014, communicate with the UE 1002 based on the SS. In some aspects, 1504 may be performed by the sequence transmission component 199.

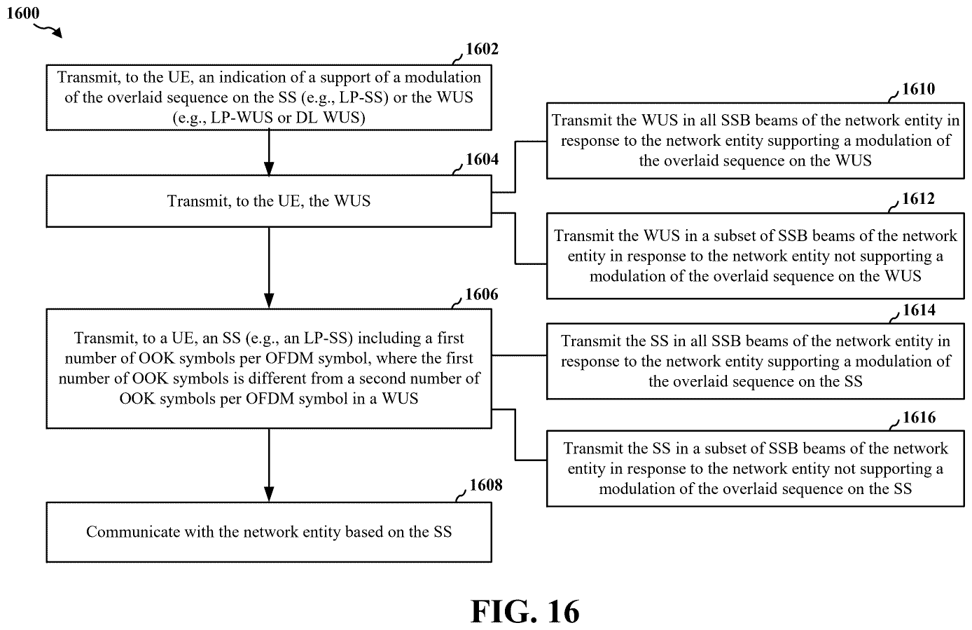

FIG. 16 is a flowchart 1600 illustrating methods of wireless communication at a network entity in accordance with various aspects of the present disclosure. The method may be performed by a network entity in collaboration with a UE. The network entity may be a base station, or a component of a base station, in the access network of FIG. 1 or a core network component (e.g., base station 102, 310, 904, 1004; or the network entity 1702 in the hardware implementation of FIG. 17). The UE may be the UE 104, 350, 1002, or the apparatus 1704 in the hardware implementation of FIG. 17. By introducing intervals of zeros (or gaps of zeros) before and after overlaid sequences, the methods prevent mixing of these sequences in multipath propagations, thereby minimizing interference between the overlaid sequences and ensuring reliable wakeup detection. Additionally, by enabling the configuration of different numbers of OOK symbols (or information bits) in an OFDM symbol for WUS and SS, the methods improve synchronization accuracy and detection reliability under various operational conditions. In some examples, by supporting WUS and SS transmissions in all or a subset of SSB beams based on network configuration, the methods ensure efficient resource utilization for varying network capabilities and coverage conditions.

As shown in FIG. 16, at 1606, the network entity may transmit, to a UE, an SS (e.g., an LP-SS). The SS may have a first number of OOK symbols per OFDM symbol. The first number of OOK symbols may be different from a second number of OOK symbols per OFDM symbol in a WUS (e.g., an LP-WUS or a DL WUS). FIG. 6B, FIG. 7, FIG. 8, FIG. 9, and FIG. 10 illustrate various aspects of the steps in connection with flowchart 1600. For example, referring to FIG. 10, the network entity (e.g., base station 1004) may, at 1014, transmit, to a UE 1002, an SS. Referring to FIG. 8, in diagram 800, the SS may have a first number (e.g., four) of OOK symbols per OFDM symbol (e.g., OFDM symbol 830), and the first number of OOK symbols may be different from a second number (e.g., two) of OOK symbols per OFDM symbol (e.g., OFDM symbol 880) in a WUS in diagram 850. In some aspects, 1606 may be performed by the sequence transmission component 199.

At 1608, the network entity may communicate with the UE based on the SS. For example, referring to FIG. 10, the network entity (e.g., base station 1004) may, at 1014, communicate with the UE 1002 based on the SS. In some aspects, 1608 may be performed by the sequence transmission component 199.

In some aspects, at 1604, the network entity may transmit, to the UE, the WUS. Each of the SS and the WUS may include multiple overlaid sequences. For example, referring to FIG. 10, the network entity (e.g., base station 1004) may, at 1008, transmit, to the UE 1002, the WUS. Each of the SS and the WUS may include multiple overlaid sequences. Referring to FIG. 8, in diagram 800, the SS may include multiple overlaid sequences (e.g., overlaid sequence #1 820, overlaid sequence #1 822). In diagram 850, the WUS may include multiple overlaid sequences (e.g., overlaid sequence #1 870, overlaid sequence #2 872). In some aspects, 1604 may be performed by the sequence transmission component 199.

In some aspects, the SS may have a larger number of OOK symbols per OFDM symbol than the WUS. That is, the first number may be greater than the second number. In that case, the length of the overlaid sequences may be based on the number of OOK symbols per OFDM symbol for the SS (i.e., the first number). For example, referring to FIG. 8, the first number may be four (e.g., four OOK symbols in OFDM symbol 830), and the second number may be two (e.g., two OOK symbols in OFDM symbol 880). The first number (e.g., four) is greater than the second number (e.g., two), and the length of the overlaid sequences is based on the first number (e.g., four).

In some aspects, the WUS may have a larger number of OOK symbols per OFDM symbol than the SS. That is, the second number may be greater than the first number. In that case, the length of the overlaid sequences is based on the number of OOK symbols per OFDM symbol for the WUS (i.e., the second number). In some aspects, the length of the overlaid sequences for the WUS may be the same as the length of the overlaid sequences for the SS.

In some aspects, at 1614, the network entity may transmit the SS in all SSB beams of the network entity if the network entity supports the modulation of the overlaid sequence on the SS. For example, referring to FIG. 10, the network entity (e.g., base station 1004) may, at 1024, transmit the SS in all SSB beams of the network entity (e.g., base station 1004) if the network entity (e.g., base station 1004) supports the modulation of the overlaid sequence on the SS. The SSB beams may correspond to transmitted SSBs. In some aspects, 1614 may be performed by the sequence transmission component 199.

In some aspects, at 1616, the network entity may transmit the SS in a subset of SSB beams of the network entity if the network entity does not support the modulation of the overlaid sequence on the SS. For example, referring to FIG. 10, the network entity (e.g., base station 1004) may, at 1026, transmit the SS in a subset of SSB beams of the network entity (e.g., base station 1004) if the network entity (e.g., base station 1004) does not support the modulation of the overlaid sequence on the SS. The subset of SSB beams may correspond to transmitted SSBs. In some aspects, 1616 may be performed by the sequence transmission component 199.

In some aspects, at 1610, the network entity may transmit the WUS in all SSB beams of the network entity if the network entity supports the modulation of the overlaid sequence on the WUS. For example, referring to FIG. 10, the network entity (e.g., base station 1004) may, at 1020, transmit the WUS in all SSB beams of the network entity (e.g., base station 1004) if the network entity (e.g., base station 1004) supports the modulation of the overlaid sequence on the WUS. The SSB beams may correspond to transmitted SSBs. In some aspects, 1610 may be performed by the sequence transmission component 199.

In some aspects, at 1612, the network entity may transmit the WUS in a subset of SSB beams of the network entity if the network entity does not support the modulation of the overlaid sequence on the WUS. For example, referring to FIG. 10, the network entity (e.g., base station 1004) may, at 1022, transmit the WUS in a subset of SSB beams of the network entity (e.g., base station 1004) if the network entity (e.g., base station 1004) does not support the modulation of the overlaid sequence on the WUS. The subset of SSB beams may correspond to transmitted SSBs. In some aspects, 1612 may be performed by the sequence transmission component 199.

In some aspects, at 1602, the network entity may transmit, to the UE, an indication of a support of the modulation of the overlaid sequence on the SS or the WUS. For example, referring to FIG. 10, the network entity (e.g., base station 1004) may, at 1006, transmit, to the UE 1002, an indication of a support of the modulation of the overlaid sequence on the SS or the WUS. In some aspects, 1602 may be performed by the sequence transmission component 199.

FIG. 17 is a diagram 1700 illustrating an example of a hardware implementation for an apparatus 1704. The apparatus 1704 may be a UE, a component of a UE, or may implement UE functionality. In some aspects, the apparatus 1704 may include at least one cellular baseband processor (or processing circuitry) 1724 (also referred to as a modem) coupled to one or more transceivers 1722 (e.g., cellular RF transceiver). The cellular baseband processor(s) (or processing circuitry) 1724 may include at least one on-chip memory (or memory circuitry) 1724′. In some aspects, the apparatus 1704 may further include one or more subscriber identity modules (SIM) cards 1720 and at least one application processor (or processing circuitry) 1706 coupled to a secure digital (SD) card 1708 and a screen 1710. The application processor(s) (or processing circuitry) 1706 may include on-chip memory (or memory circuitry) 1706′. In some aspects, the apparatus 1704 may further include a Bluetooth module 1712, a WLAN module 1714, an SPS module 1716 (e.g., GNSS module), one or more sensor modules 1718 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1726, a power supply 1730, and/or a camera 1732. The Bluetooth module 1712, the WLAN module 1714, and the SPS module 1716 may include an on-chip transceiver (TRX) (or in some cases, just a receiver (RX)). The Bluetooth module 1712, the WLAN module 1714, and the SPS module 1716 may include their own dedicated antennas and/or utilize the antennas 1780 for communication. The cellular baseband processor(s) (or processing circuitry) 1724 communicates through the transceiver(s) 1722 via one or more antennas 1780 with the UE 104 and/or with an RU associated with a network entity 1702. The cellular baseband processor(s) (or processing circuitry) 1724 and the application processor(s) (or processing circuitry) 1706 may each include a computer-readable medium/memory (or memory circuitry) 1724′, 1706′, respectively. The additional memory modules 1726 may also be considered a computer-readable medium/memory (or memory circuitry). Each computer-readable medium/memory (or memory circuitry) 1724′, 1706′, 1726 may be non-transitory. The cellular baseband processor(s) (or processing circuitry) 1724 and the application processor(s) (or processing circuitry) 1706 are each responsible for general processing, including the execution of software stored on the computer-readable medium/memory (or memory circuitry). The software, when executed by the cellular baseband processor(s) (or processing circuitry) 1724/application processor(s) (or processing circuitry) 1706, causes the cellular baseband processor(s) (or processing circuitry) 1724/application processor(s) (or processing circuitry) 1706 to perform the various functions described supra. The cellular baseband processor(s) (or processing circuitry) 1724 and the application processor(s) (or processing circuitry) 1706 are configured to perform the various functions described supra based at least in part of the information stored in the memory (or memory circuitry). That is, the cellular baseband processor(s) (or processing circuitry) 1724 and the application processor(s) (or processing circuitry) 1706 may be configured to perform a first subset of the various functions described supra without information stored in the memory and may be configured to perform a second subset of the various functions described supra based on the information stored in the memory. The computer-readable medium/memory (or memory circuitry) may also be used for storing data that is manipulated by the cellular baseband processor(s) (or processing circuitry) 1724/application processor(s) (or processing circuitry) 1706 when executing software. The cellular baseband processor(s) (or processing circuitry) 1724/application processor(s) (or processing circuitry) 1706 may be a component of the UE 350 and may include the at least one memory 360 and/or at least one of the TX processor 368, the RX processor 356, and the controller/processor 359. In one configuration, the apparatus 1704 may be at least one processor chip (modem and/or application) and include just the cellular baseband processor(s) (or processing circuitry) 1724 and/or the application processor(s) (or processing circuitry) 1706, and in another configuration, the apparatus 1704 may be the entire UE (e.g., see UE 350 of FIG. 3) and include the additional modules of the apparatus 1704.

As discussed supra, in some aspects, the component 198 may be configured to receive, from a network entity, a WUS (e.g., an LP-WUS or a DL WUS) including multiple overlaid sequences, where the WUS includes a first zero interval that is adjacent to the beginning of one or more overlaid sequences of the multiple overlaid sequences and a second zero interval that is adjacent to the end of one or more overlaid sequences of the multiple overlaid sequences; and monitor for a PDCCH based on the WUS. In some aspects, the component 198 may be configured to receive, from a network entity, an SS (e.g., an LP-SS), where the SS has a first number of OOK symbols per OFDM symbol, where the first number of OOK symbols is different from a second number of OOK symbols per OFDM symbol in a WUS (e.g., an LP-WUS or a DL WUS); and communicate with the network entity based on the SS. The component 198 may be further configured to perform any of the aspects described in connection with the flowcharts in FIG. 11, FIG. 12, and FIG. 13, and/or performed by the UE 1002 in FIG. 10. The component 198 may be within the cellular baseband processor(s) (or processing circuitry) 1724, the application processor(s) (or processing circuitry) 1706, or both the cellular baseband processor(s) (or processing circuitry) 1724 and the application processor(s) (or processing circuitry) 1706. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1704 may include a variety of components configured for various functions. In one configuration, the apparatus 1704, and in particular the cellular baseband processor(s) (or processing circuitry) 1724 and/or the application processor(s) (or processing circuitry) 1706, includes means for receiving, from a network entity, a WUS (e.g., an LP-WUS or a DL WUS) including multiple overlaid sequences, where the WUS includes a first zero interval that is adjacent to the beginning of one or more overlaid sequences of the multiple overlaid sequences and a second zero interval that is adjacent to the end of one or more overlaid sequences of the multiple overlaid sequences; and means for monitoring for a PDCCH based on the WUS. In one configuration, the apparatus 1704, and in particular the cellular baseband processor(s) (or processing circuitry) 1724 and/or the application processor(s) (or processing circuitry) 1706, includes means for receiving, from a network entity, an SS (e.g., an LP-SS), where the SS has a first number of OOK symbols per OFDM symbol, where the first number of OOK symbols is different from a second number of OOK symbols per OFDM symbol in a WUS (e.g., an LP-WUS or a DL WUS); and means for communicating with the network entity based on the SS. The apparatus 1704 may further include means for performing any of the aspects described in connection with the flowcharts in FIG. 11, FIG. 12, and FIG. 13, and/or aspects performed by the UE 1002 in FIG. 10. The means may be the component 198 of the apparatus 1704 configured to perform the functions recited by the means. As described supra, the apparatus 1704 may include the TX processor 368, the RX processor 356, and the controller/processor 359. As such, in one configuration, the means may be the TX processor 368, the RX processor 356, and/or the controller/processor 359 configured to perform the functions recited by the means.

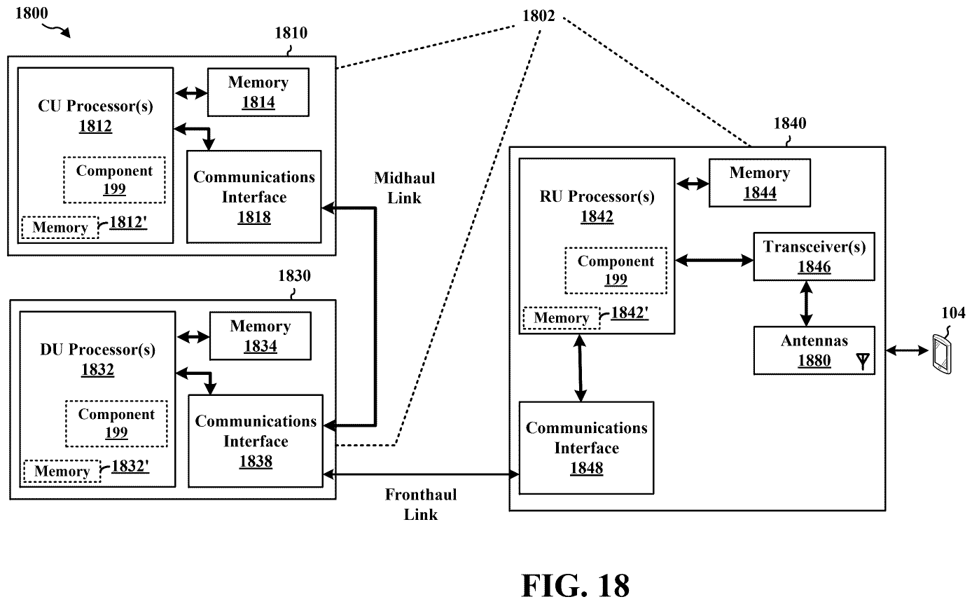

FIG. 18 is a diagram 1800 illustrating an example of a hardware implementation for a network entity 1802. The network entity 1802 may be a BS, a component of a BS, or may implement BS functionality. The network entity 1802 may include at least one of a CU 1810, a DU 1830, or an RU 1840. For example, depending on the layer functionality handled by the component 199, the network entity 1802 may include the CU 1810; both the CU 1810 and the DU 1830; each of the CU 1810, the DU 1830, and the RU 1840; the DU 1830; both the DU 1830 and the RU 1840; or the RU 1840. The CU 1810 may include at least one CU processor (or processing circuitry) 1812. The CU processor(s) (or processing circuitry) 1812 may include on-chip memory (or memory circuitry) 1812′. In some aspects, the CU 1810 may further include additional memory modules 1814 and a communications interface 1818. The CU 1810 communicates with the DU 1830 through a midhaul link, such as an F1 interface. The DU 1830 may include at least one DU processor (or processing circuitry) 1832. The DU processor(s) (or processing circuitry) 1832 may include on-chip memory (or memory circuitry) 1832′. In some aspects, the DU 1830 may further include additional memory modules 1834 and a communications interface 1838. The DU 1830 communicates with the RU 1840 through a fronthaul link. The RU 1840 may include at least one RU processor (or processing circuitry) 1842. The RU processor(s) (or processing circuitry) 1842 may include on-chip memory (or memory circuitry) 1842′. In some aspects, the RU 1840 may further include additional memory modules 1844, one or more transceivers 1846, antennas 1880, and a communications interface 1848. The RU 1840 communicates with the UE 104. The on-chip memory (or memory circuitry) 1812′, 1832′, 1842′ and the additional memory modules 1814, 1834, 1844 may each be considered a computer-readable medium/memory (or memory circuitry). Each computer-readable medium/memory (or memory circuitry) may be non-transitory. Each of the processors (or processing circuitry) 1812, 1832, 1842 is responsible for general processing, including the execution of software stored on the computer-readable medium/memory (or memory circuitry). The software, when executed by the corresponding processor(s) (or processing circuitry) causes the processor(s) (or processing circuitry) to perform the various functions described supra. The computer-readable medium/memory (or memory circuitry) may also be used for storing data that is manipulated by the processor(s) (or processing circuitry) when executing software.

As discussed supra, in some aspects, the component 199 may be configured to transmit, to a UE, a WUS (e.g., an LP-WUS or a DL WUS) including multiple overlaid sequences, where the WUS includes a first zero interval that is adjacent to the beginning of one or more overlaid sequences of the multiple overlaid sequences and a second zero interval that is adjacent to the end of one or more overlaid sequences of the multiple overlaid sequences; and transmit, to the UE, a PDCCH based on the WUS. In some aspects, the component 199 may be configured to transmit, to a UE, an SS (e.g., an LP-SS), where the SS has a first number of OOK symbols per OFDM symbol, where the first number of OOK symbols is different from a second number of OOK symbols per OFDM symbol in a WUS (e.g., an LP-WUS or a DL WUS); and communicate with the UE based on the SS. The component 199 may be further configured to perform any of the aspects described in connection with the flowcharts in FIG. 14, FIG. 15, and FIG. 16, and/or performed by the base station 1004 in FIG. 10. The component 199 may be within one or more processors (or processing circuitry) of one or more of the CU 1810, DU 1830, and the RU 1840. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1802 may include a variety of components configured for various functions. In one configuration, the network entity 1802 includes means for transmitting, to a UE, a WUS (e.g., an LP-WUS or a DL WUS) including multiple overlaid sequences, where the WUS includes a first zero interval that is adjacent to the beginning of one or more overlaid sequences of the multiple overlaid sequences and a second zero interval that is adjacent to the end of one or more overlaid sequences of the multiple overlaid sequences; and means for transmitting, to the UE, a PDCCH based on the WUS. In one configuration, the network entity 1802 includes means for transmitting, to a UE, an SS (e.g., an LP-SS), where the SS has a first number of OOK symbols per OFDM symbol, where the first number of OOK symbols is different from a second number of OOK symbols per OFDM symbol in a WUS (e.g., an LP-WUS or a DL WUS); and means for communicating with the UE based on the SS. The network entity 1802 may further include means for performing any of the aspects described in connection with the flowcharts in FIG. 14, FIG. 15, and FIG. 16, and/or aspects performed by the base station 1004 in FIG. 10. The means may be the component 199 of the network entity 1802 configured to perform the functions recited by the means. As described supra, the network entity 1802 may include the TX processor 316, the RX processor 370, and the controller/processor 375. As such, in one configuration, the means may be the TX processor 316, the RX processor 370, and/or the controller/processor 375 configured to perform the functions recited by the means.

This disclosure provides a method for wireless communication at a UE. In some aspects, the method may include receiving, from a network entity, a WUS (e.g., an LP-WUS or a DL WUS) including multiple overlaid sequences, where the WUS includes a first zero interval that is adjacent to the beginning of one or more overlaid sequences of the multiple overlaid sequences and a second zero interval that is adjacent to the end of one or more overlaid sequences of the multiple overlaid sequences; and monitoring for a PDCCH based on the WUS. In some aspects, the method may include receiving, from a network entity, an SS (e.g., an LP-SS), where the SS has a first number of OOK symbols per OFDM symbol, where the first number of OOK symbols is different from a second number of OOK symbols per OFDM symbol in a WUS (e.g., an LP-WUS or a DL WUS); and communicating with the network entity based on the SS. By introducing intervals of zeros (or gaps of zeros) before and after overlaid sequences, the methods prevent mixing of these sequences in multipath propagations, thereby minimizing interference between the overlaid sequences and ensuring reliable wakeup detection. Additionally, by enabling the configuration of different numbers of OOK symbols (or information bits) in an OFDM symbol for WUS and SS, the methods improve synchronization accuracy and detection reliability under various operational conditions. In some examples, by supporting WUS and SS transmissions in all or a subset of SSB beams based on network configuration, the methods ensure efficient resource utilization for varying network capabilities and coverage conditions.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor (i.e., a set of one or more processor P) is configured to perform a set of functions F, each processor of P may be configured to perform a subset S of F, where S & F. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently. As used herein, the phrase “associated with” encompasses any association, relation, or connection link. Among other examples, the phrase “associated with” may include in association with, based on, based at least in part on, corresponding to, related to, in response to, linked with, and/or connected with. As used herein, “using” may include any use, which may include any consideration, any calculation, and/or any dependency, among examples of use.

The following aspects are illustrative only and may be combined with other aspects or teachings described herein, without limitation.

Aspect 1 is a method of wireless communication at a UE. The method includes receiving, from a network entity, a wakeup signal (WUS) comprising multiple overlaid sequences, wherein the WUS includes a first zero interval that is adjacent to a beginning of one or more overlaid sequences of the multiple overlaid sequences and a second zero interval that is adjacent to an end of one or more overlaid sequences of the multiple overlaid sequences; and monitoring for a physical downlink control channel (PDCCH) based on the WUS.

Aspect 2 is the method of aspect 1, wherein a sum of the first zero interval and the second zero interval is greater than or equal to a cyclic prefix (CP) duration of the WUS.

Aspect 3 is the method of any of aspects 1 to 2, wherein the WUS includes the first zero interval that is adjacent to the beginning of two or more overlaid sequences of the multiple overlaid sequences, and wherein the WUS further includes the second zero interval that is adjacent to the end of the two or more overlaid sequences of the multiple overlaid sequences.

Aspect 4 is the method of any of aspects 1 to 2, wherein a first length of the first zero interval is N₁, a second length of the second zero interval is N₂, and a third length of the CP duration is N_{cp}, and wherein N₁=0, N₂=N_{cp}, or N₁=N_{cp}, N₂=0, or Ni= └N_{cp}/2┘, N₂=N_{cp}−N₁, or N₁=N_{cp}−N₂, N₂=└N_{cp}/2┘.

Aspect 5 is an apparatus for wireless communication at a UE, comprising: a processing system that includes processor circuitry and memory circuitry that stores code and is coupled with the processor circuitry, the processing system configured to cause the UE to perform the method of one or more of aspects 1-4.

Aspect 6 is an apparatus for wireless communication at a UE, comprising: at least one memory; and at least one processor coupled to the at least one memory and, where the at least one processor is configured to perform the method of any of aspects 1-4.

Aspect 7 is the apparatus for wireless communication at a UE, comprising means for performing each step in the method of any of aspects 1-4.

Aspect 8 is an apparatus of any of aspects 5-7, further comprising a transceiver configured to receive or to transmit in association with the method of any of aspects 1-4.

Aspect 9 is a computer-readable medium (e.g., a non-transitory computer-readable medium) storing computer executable code at a UE, the code when executed by at least one processor causes the at least one processor to perform the method of any of aspects 1-4.

Aspect 10 is a method of wireless communication at a UE. The method includes receiving, from a network entity, a synchronization signal (SS) including a first number of on-off keying (OOK) symbols per orthogonal frequency-division multiplexing (OFDM) symbol, wherein the first number of OOK symbols is different from a second number of OOK symbols per OFDM symbol in a wakeup signal (WUS); and communicating with the network entity based on the SS.

Aspect 11 is the method of aspect 10, where the method further includes receiving, from the network entity, the WUS, wherein each of the SS and the WUS comprises multiple overlaid sequences.

Aspect 12 is the method of any of aspects 10 to 11, wherein the first number is greater than the second number, and wherein a length of the overlaid sequences is based on the first number.

Aspect 13 is the method of any of aspects 10 to 11, wherein the second number is greater than the first number, and wherein a length of the overlaid sequences is based on the second number.

Aspect 14 is the method of any of aspects 10 to 11, wherein a first length of the overlaid sequences for the WUS is same as a second length of the overlaid sequences for the SS.

Aspect 15 is the method of any of aspects 10 to 11, where receiving the SS includes receiving the SS in all synchronization signal block (SSB) beams of the network entity for transmitted SSBs in response to the network entity supporting a modulation of the overlaid sequence on the SS.

Aspect 16 is the method of any of aspects 10 to 11, wherein receiving the SS includes receiving the SS in a subset of synchronization signal block (SSB) beams of the network entity for transmitted SSBs in response to the network entity not supporting a modulation of the overlaid sequence on the SS.

Aspect 17 is the method of aspect 11, wherein receiving the WUS includes receiving the WUS in all synchronization signal block (SSB) beams of the network entity for transmitted SSBs in response to the network entity supporting a modulation of the overlaid sequence on the WUS.

Aspect 18 is the method of aspect 11, wherein receiving the WUS includes receiving the WUS in a subset of synchronization signal block (SSB) beams of the network entity for transmitted SSBs in response to the network entity not supporting a modulation of the overlaid sequence on the WUS.

Aspect 19 is the method of any of aspects 11 to 18, where the method further includes receiving, from the network entity, an indication of a support of a modulation of the overlaid sequence on the SS or the WUS.

Aspect 20 is an apparatus for wireless communication at a UE, comprising: a processing system that includes processor circuitry and memory circuitry that stores code and is coupled with the processor circuitry, the processing system configured to cause the UE to perform the method of one or more of aspects 10-19.

Aspect 21 is an apparatus for wireless communication at a UE, comprising: at least one memory; and at least one processor coupled to the at least one memory and, where the at least one processor is configured to perform the method of any of aspects 10-19.

Aspect 22 is the apparatus for wireless communication at a UE, comprising means for performing each step in the method of any of aspects 10-19.

Aspect 23 is an apparatus of any of aspects 20-22, further comprising a transceiver configured to receive or to transmit in association with the method of any of aspects 10-19.

Aspect 24 is a computer-readable medium (e.g., a non-transitory computer-readable medium) storing computer executable code at a UE, the code when executed by at least one processor causes the at least one processor to perform the method of any of aspects 10-19.

Aspect 25 is a method of wireless communication at a network entity. The method includes transmitting, to a user equipment (UE), a wakeup signal (WUS) comprising multiple overlaid sequences, wherein the WUS includes a first zero interval that is adjacent to a beginning of one or more overlaid sequences of the multiple overlaid sequences and a second zero interval that is adjacent to an end of one or more overlaid sequences of the multiple overlaid sequences; and transmitting, to the UE, a physical downlink control channel (PDCCH) based on the WUS.

Aspect 26 is the method of aspect 25, wherein a sum of the first zero interval and the second zero interval is greater than or equal to a cyclic prefix (CP) duration of the WUS.

Aspect 27 is the method of any of aspects 25 to 26, wherein the WUS includes the first zero interval that is adjacent to the beginning of two or more overlaid sequences of the multiple overlaid sequences, and wherein the WUS further includes the second zero interval that is adjacent to the end of the two or more overlaid sequences of the multiple overlaid sequences.

Aspect 28 is the method of any of aspects 25 to 26, wherein a first length of the first zero interval is N₁, a second length of the second zero interval is N₂, and a third length of the CP duration is N_{cp}, and wherein N₁=0, N₂=N_{cp}, or N₁=N_{cp}, N₂=0, or N₁= [N_{cp}/2], N₂=N_{cp}−N₁, or N₁=N_{cp}−N₂, N₂= [N_{cp}/2].

Aspect 29 is an apparatus for wireless communication at a network entity, comprising: a processing system that includes processor circuitry and memory circuitry that stores code and is coupled with the processor circuitry, the processing system configured to cause the network entity to perform the method of one or more of aspects 25-28.

Aspect 30 is an apparatus for wireless communication at a network entity, comprising: at least one memory; and at least one processor coupled to the at least one memory and, where the at least one processor is configured to perform the method of any of aspects 25-28.

Aspect 31 is the apparatus for wireless communication at a network entity, comprising means for performing each step in the method of any of aspects 25-28.

Aspect 32 is an apparatus of any of aspects 29-31, further comprising a transceiver configured to receive or to transmit in association with the method of any of aspects 25-28.

Aspect 33 is a computer-readable medium (e.g., a non-transitory computer-readable medium) storing computer executable code at a network entity, the code when executed by at least one processor causes the at least one processor to perform the method of any of aspects 25-28.

Aspect 34 is a method of wireless communication at a network entity. The method includes transmitting, to a user equipment (UE), a synchronization signal (SS) including a first number of on-off keying (OOK) symbols per orthogonal frequency-division multiplexing (OFDM) symbol, wherein the first number of OOK symbols is different from a second number of OOK symbols per OFDM symbol in a wakeup signal (WUS); and communicating with the UE based on the SS.

Aspect 35 is the method of aspect 34, where the method further includes transmitting, to the UE, the WUS, wherein each of the SS and the WUS comprises multiple overlaid sequences.

Aspect 36 is the method of any of aspects 34 to 35, wherein the first number is greater than the second number, and wherein a length of the overlaid sequences is based on the first number.

Aspect 37 is the method of any of aspects 34 to 35, wherein the second number is greater than the first number, and wherein a length of the overlaid sequences is based on the second number.

Aspect 38 is the method of any of aspects 34 to 35, wherein a first length of the overlaid sequences for the WUS is same as a second length of the overlaid sequences for the SS.

Aspect 39 is the method of any of aspects 34 to 35, wherein transmitting the SS includes transmitting the SS in all synchronization signal block (SSB) beams of the network entity corresponding to transmitted SSBs in response to the network entity supporting a modulation of the overlaid sequence on the SS.

Aspect 40 is the method of any of aspects 34 to 35, wherein transmitting the SS includes transmitting the SS in a subset of synchronization signal block (SSB) beams of the network entity corresponding to transmitted SSBs in response to the network entity not supporting a modulation of the overlaid sequence on the SS.

Aspect 41 is the method of aspect 35, wherein transmitting the WUS includes transmitting the WUS in all synchronization signal block (SSB) beams of the network entity corresponding to transmitted SSBs in response to the network entity supporting a modulation of the overlaid sequence on the WUS.

Aspect 42 is the method of aspect 35, wherein transmitting the WUS includes transmitting the WUS in a subset of synchronization signal block (SSB) beams of the network entity corresponding to transmitted SSBs in response to the network entity not supporting a modulation of the overlaid sequence on the WUS.

Aspect 43 is the method of any of aspects 35 to 42, where the method further includes transmitting, to the UE, an indication of a support of a modulation of the overlaid sequence on the SS or the WUS.

Aspect 44 is an apparatus for wireless communication at a network entity, comprising: a processing system that includes processor circuitry and memory circuitry that stores code and is coupled with the processor circuitry, the processing system configured to cause the network entity to perform the method of one or more of aspects 34-43.

Aspect 45 is an apparatus for wireless communication at a network entity, comprising: at least one memory; and at least one processor coupled to the at least one memory and, where the at least one processor is configured to perform the method of any of aspects 34-43.

Aspect 46 is the apparatus for wireless communication at a network entity, comprising means for performing each step in the method of any of aspects 34-43.

Aspect 47 is an apparatus of any of aspects 44-46, further comprising a transceiver configured to receive or to transmit in association with the method of any of aspects 34-43

Aspect 48 is a computer-readable medium (e.g., a non-transitory computer-readable medium) storing computer executable code at a network entity, the code when executed by at least one processor causes the at least one processor to perform the method of any of aspects 34-43.

What is claimed is:

1. An apparatus for wireless communication at a user equipment (UE), comprising:
at least one memory; and
at least one processor coupled to the at least one memory and, based at least in part on information stored in the at least one memory, the at least one processor is configured to:
receive, from a network entity, a wakeup signal (WUS) comprising multiple overlaid sequences, wherein the WUS includes a first zero interval that is adjacent to a beginning of one or more overlaid sequences of the multiple overlaid sequences and a second zero interval that is adjacent to an end of the one or more overlaid sequences of the multiple overlaid sequences; and
monitor for a physical downlink control channel (PDCCH) based on the WUS.

2. The apparatus of claim 1, further comprising a transceiver coupled to the at least one processor, wherein to receive the WUS, the at least one processor is configured to receive the WUS via the transceiver, and wherein a sum of the first zero interval and the second zero interval is greater than or equal to a cyclic prefix (CP) duration of the WUS.

3. The apparatus of claim 2, wherein the WUS includes the first zero interval that is adjacent to the beginning of two or more overlaid sequences of the multiple overlaid sequences, and wherein the WUS further includes the second zero interval that is adjacent to the end of the two or more overlaid sequences of the multiple overlaid sequences.

4. The apparatus of claim 2, wherein a first length of the first zero interval is N₁, a second length of the second zero interval is N₂, and a third length of the CP duration is N_{cp}, and wherein:
$${N}_{1} = 0 , {N}_{2} = {N}_{c p} , {N}_{1} = {N}_{c p} , {N}_{2} = 0 , {N}_{1} = ⌊ {N}_{c p} / 2 ⌋ , {N}_{2} = {N}_{c p} - {N}_{1} , or \\ {N}_{1} = {N}_{c p} - {N}_{2} , {N}_{2} = ⌊ {N}_{c p} / 2 ⌋ .$$

5. An apparatus for wireless communication at a user equipment (UE), comprising:
at least one memory; and
at least one processor coupled to the at least one memory and, based at least in part on information stored in the at least one memory, the at least one processor is configured to:
receive, from a network entity, a synchronization signal (SS) including a first number of on-off keying (OOK) symbols per orthogonal frequency-division multiplexing (OFDM) symbol, wherein the first number of OOK symbols is different from a second number of OOK symbols per OFDM symbol in a wakeup signal (WUS); and
communicate with the network entity based on the SS.

6. The apparatus of claim 5, further comprising a transceiver coupled to the at least one processor, wherein to receive the SS, the at least one processor is configured to receive the SS via the transceiver, and wherein the at least one processor is further configured to:
receive, from the network entity, the WUS, wherein each of the SS and the WUS comprises multiple overlaid sequences.

7. The apparatus of claim 6, wherein the first number is greater than the second number, and wherein a length of the overlaid sequences is based on the first number.

8. The apparatus of claim 6, wherein the second number is greater than the first number, and wherein a length of the overlaid sequences is based on the second number.

9. The apparatus of claim 6, wherein a first length of the overlaid sequences for the WUS is same as a second length of the overlaid sequences for the SS.

10. The apparatus of claim 6, wherein to receive the SS, the at least one processor is configured to:
receive the SS in all synchronization signal block (SSB) beams of the network entity corresponding to transmitted SSBs in response to the network entity supporting a modulation of the overlaid sequence on the SS.

11. The apparatus of claim 6, wherein to receive the SS, the at least one processor is configured to:
receive the SS in a subset of synchronization signal block (SSB) beams of the network entity for transmitted SSBs in response to the network entity not supporting a modulation of the overlaid sequence on the SS.

12. The apparatus of claim 6, wherein to receive the WUS, the at least one processor is configured to:
receive the WUS in all synchronization signal block (SSB) beams of the network entity for transmitted SSBs in response to the network entity supporting a modulation of the overlaid sequence on the WUS.

13. The apparatus of claim 6, wherein to receive the WUS, the at least one processor is configured to:
receive the WUS in a subset of synchronization signal block (SSB) beams of the network entity for transmitted SSBs in response to the network entity not supporting a modulation of the overlaid sequence on the WUS.

14. The apparatus of claim 6, wherein the at least one processor is further configured to:
receive, from the network entity, an indication of a support of a modulation of the overlaid sequence on the SS or the WUS.

15. An apparatus for wireless communication at a network entity, comprising:
at least one memory; and
at least one processor coupled to the at least one memory and, based at least in part on information stored in the at least one memory, the at least one processor is configured to:
transmit, to a user equipment (UE), a synchronization signal (SS) including a first number of on-off keying (OOK) symbols per orthogonal frequency-division multiplexing (OFDM) symbol, wherein the first number of OOK symbols is different from a second number of OOK symbols per OFDM symbol in a wakeup signal (WUS); and
communicate with the UE based on the SS.

16. The apparatus of claim 15, further comprising a transceiver coupled to the at least one processor, wherein to transmit the SS, the at least one processor is configured to transmit the SS via the transceiver, and wherein the at least one processor is further configured to:
transmit, to the UE, the WUS, wherein each of the SS and the WUS comprises multiple overlaid sequences.

17. The apparatus of claim 16, wherein the first number is greater than the second number, and wherein a length of the overlaid sequences is based on the first number.

18. The apparatus of claim 16, wherein to transmit the SS, the at least one processor is configured to:
transmit the SS in all synchronization signal block (SSB) beams of the network entity in response to the network entity supporting a modulation of the overlaid sequence on the SS.

19. The apparatus of claim 16, wherein to transmit the SS, the at least one processor is configured to:
transmit the SS in a subset of synchronization signal block (SSB) beams of the network entity in response to the network entity not supporting a modulation of the overlaid sequence on the SS.

20. The apparatus of claim 16, wherein to transmit the WUS, the at least one processor is configured to:
transmit the WUS in all synchronization signal block (SSB) beams of the network entity in response to the network entity supporting a modulation of the overlaid sequence on the WUS.
